(19) United States
(12) Patent Application Publication
(10) Pub. No.: US 2025/0021101 A1
(43) Pub. Date: Jan. 16, 2025

(54) ROW-BASED WORLD MODEL FOR PERCEPTIVE NAVIGATION

(71) Applicant: FARMX Inc., Mountain View, CA (US)

(72) Inventor: Edward Lee Koch, Newberry, FL (US)

(21) Appl. No.: 18/797,321

(22) Filed: Aug. 7, 2024

Related U.S. Application Data
(63) Continuation-in-part of application No. 18/233,096, filed on Aug. 11, 2023, now Pat. No. 12,079,011.
Application No. 18/233,096 is a continuation of application No. 17/153,511, filed on Jan. 20, 2021, now Pat. No. 11,726,501.
Application No. 17/153,511 is a continuation of application No. 16/174,278, filed on Oct. 29, 2018, now Pat. No. 10,921,825.
(60) Provisional application No. 62/581,687, filed on Nov. 4, 2017.

(51) Int. Cl. G05D 1/00; B64C 39/02; G05D 1/46; G08G 5/00

(52) U.S. Cl. CPC G05D 1/101; B64C 39/024; G05D 1/46; G08G 5/0034; B64U 2201/10; B64U 2201/104

(57) ABSTRACT

A system, method, and autonomous vehicle (AV) that generates a row-based world model for perceptive navigation of an AV are described. The system includes a client device, a cloud component, and the AV. The client device receives a map image of a field having a plurality of rows, in which each row includes a plurality of plants. The cloud component then generates a row-based frame of reference, in which each row has an associated frame of reference that includes a distance. A location is determined based on a row number and the distance associated with the row number. The cloud component also associates a semantic instruction with the row-based world model, and the cloud component communicates the row-based world model to the AV.

### CROSS REFERENCE

This patent application is a Continuation-In-Part patent application of Ser. No. 18/233,096 entitled SYSTEM AND METHOD FOR PERCEPTIVE NAVIGATION OF AUTOMATED VEHICLES filed on Aug. 11, 2023,
which is a Continuation of patent application Ser. No. 17/153,511 (now U.S. Pat. No. 11,726,501), entitled SYSTEM AND METHOD FOR PERCEPTIVE NAVIGATION OF AUTOMATED VEHICLES filed on Jan. 20, 2021,
which is a continuation of patent application Ser. No. 16/174,278 (now U.S. Pat. No. 10,921,825), entitled SYSTEM AND METHOD FOR PERCEPTIVE NAVIGATION OF AUTOMATED VEHICLES filed on Oct. 29, 2018,
which claims the benefit of provisional patent application 62/581,687 entitled SYSTEM AND METHOD FOR PERCEPTIVE NAVIGATION OF AUTOMATED VEHICLES having a filing date of Nov. 4, 2017;
all of which are incorporated by reference in this patent application filing.

### FIELD

The present disclosure relates to a row-based world model for perceptive navigation. More particularly, the present disclosure relates to a system, method, and autonomous vehicle (AV) that generates a row-based world model for perceptive navigation of an AV.

### BACKGROUND

In the context of an autonomous vehicle, a world model is a digital representation of the environment in which the vehicle operates. Autonomous vehicles (AVs) include autonomous tractors, unmanned air vehicles, unmanned ground vehicles, unmanned aquatic vehicles and other such unmanned vehicles. Airborne AVs are reusable unmanned vehicles capable of controlled, sustained and level movement or flight. AVs can be powered by a jet, a reciprocating engine, or be entirely electric with an onboard battery. AVs can be used to provide remote sensing capabilities and can generate high resolution images.

Generally, the world model includes information about the road network, the location and movement of other vehicles, pedestrians, and any other objects that may be relevant to the vehicle's navigation and decision-making. The world model is continuously updated based on sensor data from the vehicle, such as cameras, lidar, radar, and GPS. The world model is a critical component of the autonomous vehicle's software, as it is used to plan the vehicle's trajectory, predict the movements of other vehicles and objects in the environment, and make decisions about how to respond to different situations. For example, if the vehicle's sensors detect a pedestrian crossing the road ahead, the world model can be used to predict the pedestrian's future trajectory, and the vehicle can then adjust its speed and path to avoid a collision.

Typically, the world model is created using machine learning algorithms, such as deep neural networks, which are trained on large datasets of sensor data. These algorithms can extract features and patterns from the data and use them to create an accurate and detailed representation of the environment. As the vehicle operates in the real world, the world model is updated in real-time based on new sensor data, ensuring that it remains up-to-date and accurate. Overall, the world model is a crucial component of an autonomous vehicle's software, as it enables the vehicle to navigate and make decisions in complex and dynamic environments.

There are several types of world models that can be created for autonomous vehicles, depending on the specific needs and requirements of the vehicle and the environment in which it operates. Some illustrative world models include 3D maps, semantic maps, occupancy grids, motion models and sensor models. Overall, the type of world model created for an autonomous vehicle will depend on the specific needs and requirements of the vehicle and the environment in which it operates. The world model is a critical component of the vehicle's software, as it enables the vehicle to navigate and make decisions in complex and dynamic environments.

SLAM (Simultaneous Localization and Mapping) is a technique used in autonomous vehicles (AVs) to generate a world model by simultaneously estimating the vehicle's position (localization) and mapping the surrounding environment. By combining mapping and localization in a simultaneous manner, SLAM enables AVs to generate and update a world model as they navigate through the environment. The world model serves as a foundation for perception, planning, and decision-making, supporting safe and efficient autonomous operation.

SLAM is used to generate a world model by using various sensors such as lidar, radar, cameras, and inertial measurement units (IMUs) to gather data about the surrounding environment. These sensors capture information about the vehicle's motion, distances to objects, and the structure of the environment. The sensor data is then processed to extract relevant features from the environment. For example, lidar sensors can detect and identify objects, while cameras can capture visual features like edges, corners, or key points. These features serve as the basis for mapping and localization.

In SLAM, the extracted features from different sensor readings are associated with each other to determine correspondences across multiple frames of data. This association helps establish relationships between observed features and their positions in the environment. Using the associated feature data, the SLAM algorithm builds a map of the environment. This map represents the world model and can include information such as the positions of objects, landmarks, road boundaries, and other relevant features. The map is continuously updated and refined as the AV explores new areas or encounters new objects. Simultaneously with mapping, SLAM estimates the vehicle's position and orientation (localization) relative to the mapped environment. By comparing the observed features with the mapped features, the AV determines its location within the world model. This localization information is continually refined as new sensor data becomes available.

As the AV moves through the environment, the SLAM system looks for opportunities to close loops in the trajectory, which means identifying previously visited areas. Loop closure helps correct accumulated errors in the map and localization estimates, enhancing their accuracy and consistency. SLAM algorithms employ optimization techniques, such as bundle adjustment, to refine the estimated map and vehicle poses. Optimization aims to minimize the discrepancies between observed features, predicted features based on the current estimates, and the geometric constraints imposed by the sensor data. SLAM algorithms are designed to work in real-time, enabling the AV to update its world model and localization estimates on the fly as new sensor data becomes available. This allows the AV to navigate and make decisions based on the most up-to-date representation of the environment.

For example, SLAM operates with sensors that are analyzed by a SLAM algorithm. The SLAM algorithm identifies distinct features, e.g., a corner, within a “field of view” in real-time. These distinct features are then used to generate a map. However, the SLAM algorithm does not associate these features with semantics and so SLAM would not be able to identify the illustrative corner. The SLAM process is repeated for a next snapshot and then matches features that were previously collected. SLAM then makes a correlation between the “views.” Location is determined based on the field of view. The SLAM algorithm collects features and time information to determine location by mapping these features together, which results in updating the map. Thus, SLAM is using current and previous views of the world and features to determine location, which is computationally intensive and sensor dependent. As a result, SLAM operates in a manner similar to dead reckoning, in which both technologies share the challenges of exponential sensor error drift.

Several challenges limit the broad implementation of SLAM, such as including little or no semantic instructions, being computationally intensive, and being subject to exponential drift. Further, each of these challenges are magnified in an agricultural environment where field hands are not, generally, technically sophisticated and there is a lack of infrastructure to support computationally intensive operations that are subject to exponential sensor drift.

Accordingly, it would be desirable to integrate semantics into a world map for agricultural applications. Also, it would be desirable to simplify the computationally intensive operations and minimize the challenges associated with exponential sensor drift in agricultural operations.

### SUMMARY

A system, method, and AV that generates a row-based world model for perceptive navigation of an autonomous vehicle (AV) is described. The system includes a client device, a cloud component, and the AV. The client device receives a map image of a field having a plurality of rows, in which each row includes a plurality of plants.

The cloud component is communicatively coupled to the client device. The map image identified by the client device is received by the cloud component. The cloud component determines a perimeter for the field. Also, the cloud component determines a row distance between at least two rows. Additionally, the cloud component determines a plant type for the plurality of plants. Furthermore, the cloud component determines an orientation for the map image elements, such as one or more rows of plants. The cloud component then generates a row-based frame of reference, in which each row has an associated frame of reference that includes a distance.

A location is determined by the cloud component based on a row number and the distance associated with the row number. The cloud component generates a row-based world model with the row-based frames of reference. The cloud component also associates a semantic instruction with the row-based world model, and the cloud component communicates the row-based world model to the AV.

In one embodiment, the cloud component includes a computer vision module that detects the perimeter of the field from the map image. In another embodiment, the cloud component includes a computer vision module that detects the row distance between the rows. In yet another embodiment, the cloud component includes a computer vision module that detects an end of each row and a beginning of each row.

In a further embodiment, the plant type is determined from a user input. In a still further embodiment, the row-based world model includes a plant height and the cloud component generates a 2.5-D world model that includes a plant height. In an even further embodiment, the row-based world model includes a 2-D world model having a plurality of horizontal information gathered from the map image.

### BRIEF DESCRIPTION OF THE DRAWINGS

The present invention will be more fully understood by reference to the following drawings which are presented for illustrative, not limiting, purposes.

FIG. 1A shows a method that generates a row-based world model for perceptive navigation of an autonomous vehicle (AV).

FIG. 1B shows a screen capture of a field having a plurality of rows.

FIG. 1C shows a screen shot of the field with a “find boundary” button.

FIGS. 1D and 1E show the process of generating and saving a perimeter boundary.

FIG. 1F shows a variety of user inputs related to row spacing and plant spacing.

FIG. 1G shows an illustrative row-based world model.

FIG. 2 shows a flowchart for generating a mission plan with the row-based world model from FIG. 1A.

FIG. 3 shows the architectural components for an AV system that supports perceptive navigation of an AV tractor.

FIG. 4 shows aerial quadcopters communicating with ground stations.

FIG. 5 shows the AV subsystems corresponding to a tractor AV.

FIG. 6 shows a detailed block diagram of the system controller.

FIG. 7 shows a ground station and the ground station functions.

FIG. 8 shows the various functions of the cloud station.

FIG. 9 shows a flowchart of a perceptive navigation control loop.

FIG. 10 shows vector to planar feature frames of reference.

FIG. 11 shows vector to line feature frames of reference.

FIG. 12 shows vector to point feature frames of reference.

FIG. 13 shows an illustrative trajectory based on Global Positioning System (GPS) coordinates.

FIG. 14 shows an asset model segmented into features.

FIG. 15 shows a feature based traversability graph.

### DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the systems and methods described herein may vary as to configuration and as to details. The following detailed description of the illustrative embodiments includes reference to the accompanying drawings, which form a part of this application. The drawings show, by way of illustration, specific embodiments in which the invention may be practiced. It is to be understood that other embodiments may be utilized and structural changes may be made without departing from the scope of the claims.

The perceptive navigation system, methods, and autonomous vehicles (AVs) described herein have been adapted for operation in an agricultural environment. Although drawing from elements of Simultaneous Location and Mapping (SLAM), the perceptive navigation systems presented operate with a frame of reference that relies on rows and distance and/or plant associated with each row. Further, the systems and methods support semantic operation, in which common agricultural terms are used, e.g., go to plant 4 in row 5.

Autonomous tractors are self-driving vehicles designed for agricultural applications. They use a combination of sensors, GPS, and advanced control systems to operate autonomously in the field, without the need for a human driver. Autonomous tractors can be used for a variety of agricultural tasks, such as planting, harvesting, and spraying. They can operate 24/7, allowing farmers to increase their productivity and efficiency, and reduce their labor costs. They can also operate more precisely and consistently than human drivers, which can lead to improved crop yields and reduced waste.

The benefits of autonomous tractors include improved crop yields, increased productivity, reduced labor costs, improved safety, and reduced waste. Additionally, autonomous tractors can perform a variety of tasks, such as planting, harvesting, and spraying, which can provide farmers with greater flexibility in their operations. Furthermore, autonomous tractors can be programmed to apply fertilizers and pesticides with greater precision, which can reduce the amount of chemicals used and minimize environmental impacts. Overall, autonomous tractors have the potential to transform agricultural operations, allowing farmers to increase their productivity, efficiency, and sustainability.

A world model refers to a digital representation or a dynamic map of the vehicle's environment. The world model serves as a crucial component of an autonomous vehicle's perception and decision-making system. It is continuously updated and maintained based on sensor data from the vehicle's onboard sensors such as cameras, lidar, radar, and other perception technologies. The sensors capture information about the vehicle's surroundings and feed it into algorithms and software systems that construct and update the world model. The world model provides the vehicle with a comprehensive understanding of the environment, enabling it to make informed decisions and navigate safely and efficiently. It aids in tasks such as object detection, lane recognition, traffic sign interpretation, path planning, and collision avoidance. The world model is a vital component that enables the autonomous vehicle to perceive, interpret, and interact with its environment, making informed decisions and executing appropriate maneuvers for safe and efficient navigation.

The world model for an autonomous tractor, autonomous drone, or the combination thereof will depend on the specific needs and requirements of the tractor or drone and the environment in which it operates. As described herein, the world model is a critical component of an AV's software because it enables the autonomous tractor or drone to navigate and make decisions in a complex and dynamic environment. The systems and methods described herein are related to generating a world model for agricultural applications.

The tractor AV and/or drone AV includes a world model having a two-dimensional (2-D) map database of the AV's environment and/or a 2.5-D map database of the AV's environment. The world model may also include a model of the AV itself, i.e., tractor, drone, or combination thereof, including the AV's operational capabilities and various AV constraints or limitations.

The following description describes a system and method for generating a simplified world model for agricultural applications. Typically, world models require scanning a large area or are associated with a world map; these world models are complex. More specifically, the simplified system and method for generating a world model can be performed by a person with limited or no programming skills. For example, the simplified world model may be generated by a farmer or a field hand.

In the illustrative embodiments presented herein, the simplified world model is generated by the tractor, drone, or a combination thereof. In the illustrative embodiment, a farmer generates a world model by creating a frame of reference for each row in a field or orchard.

A frame of reference refers to a coordinate system or a set of reference points used to define and measure the position, orientation, and motion of the vehicle and its surroundings. The frame of reference serves as a spatial reference for the vehicle's perception, localization, mapping, and navigation systems. An autonomous vehicle typically operates within a three-dimensional space, and a frame of reference helps establish a consistent and standardized way to understand the vehicle's position and movement relative to its environment. It provides a basis for interpreting sensor data, planning trajectories, and making navigation decisions.

There are different types of frames of reference used in autonomous vehicles, including a global frame of reference, a local frame of reference and an ego-centric frame of reference. The global frame of reference refers to a coordinate system based on an absolute reference, such as latitude and longitude or a global positioning system (GPS). The global frame of reference allows the vehicle to determine its position on a global scale, enabling navigation and localization across different areas. The local frame of reference is a coordinate system that is specific to the vehicle's immediate surroundings and may be defined relative to a fixed point or landmark, such as a starting position or a known reference point. The local frame of reference is useful for short-term navigation and perception tasks, such as obstacle detection and avoidance. The ego-centric frame of reference refers to a coordinate system centered on the vehicle itself and is often used for perception tasks, where the vehicle's sensors, such as cameras and lidar, generate data relative to the vehicle's position and orientation. The ego-centric frame of reference allows the vehicle to interpret sensor measurements and understand its immediate surroundings.

The choice of frame of reference depends on the specific requirements and capabilities of the autonomous vehicle system. Multiple frames of reference can be used simultaneously or in combination to provide a comprehensive understanding of the vehicle's position and orientation within its environment. For the purposes of this patent, one or more frames of reference can be used for navigation, monitoring, spraying, and other such operations.

However, the simplified world model described herein is generated by a farmer or a field worker using a “row” as the frame of reference. In farming, a “row” refers to a linear arrangement of crops or plants that are sown, planted, or cultivated in a straight line. Rows are commonly used in various agricultural practices, including crop cultivation, gardening, and horticulture. When crops are planted in rows, they are typically spaced apart at regular intervals to allow for optimal growth and access to sunlight, water, and nutrients. The distance between rows can vary depending on the specific crop and farming practices. The number of rows in a field depends on various factors such as crop type, available land, equipment used, and farming techniques. Farmers carefully plan the spacing and arrangement of rows to optimize yield, manage resources effectively, and streamline farming operations.

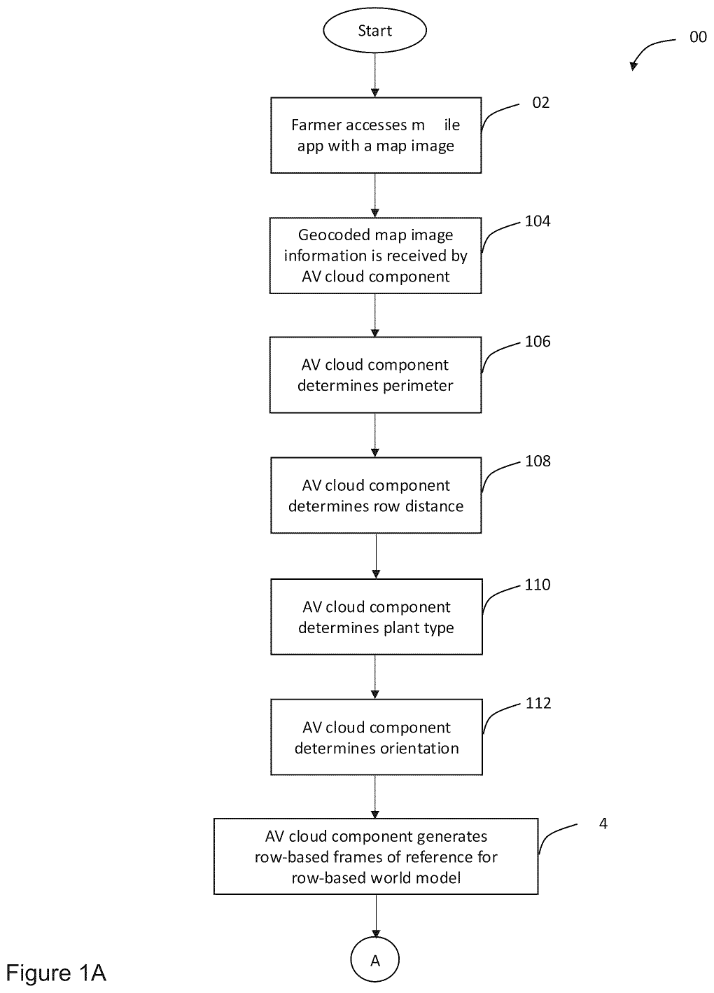

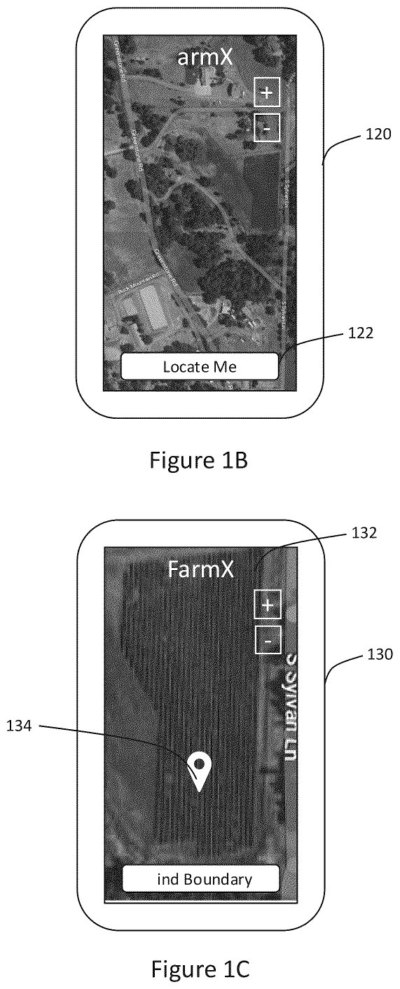

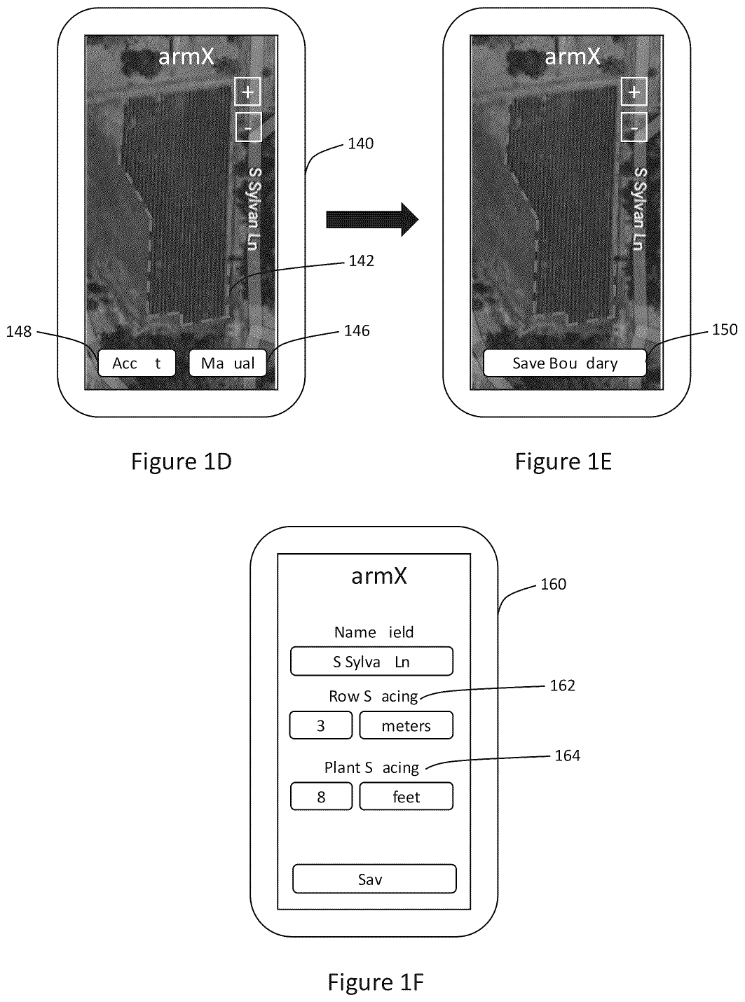

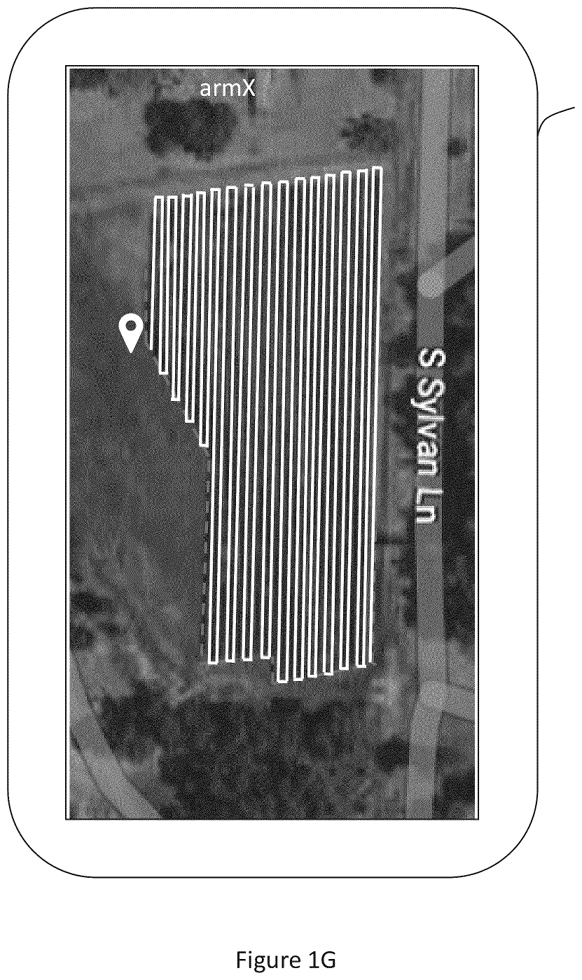

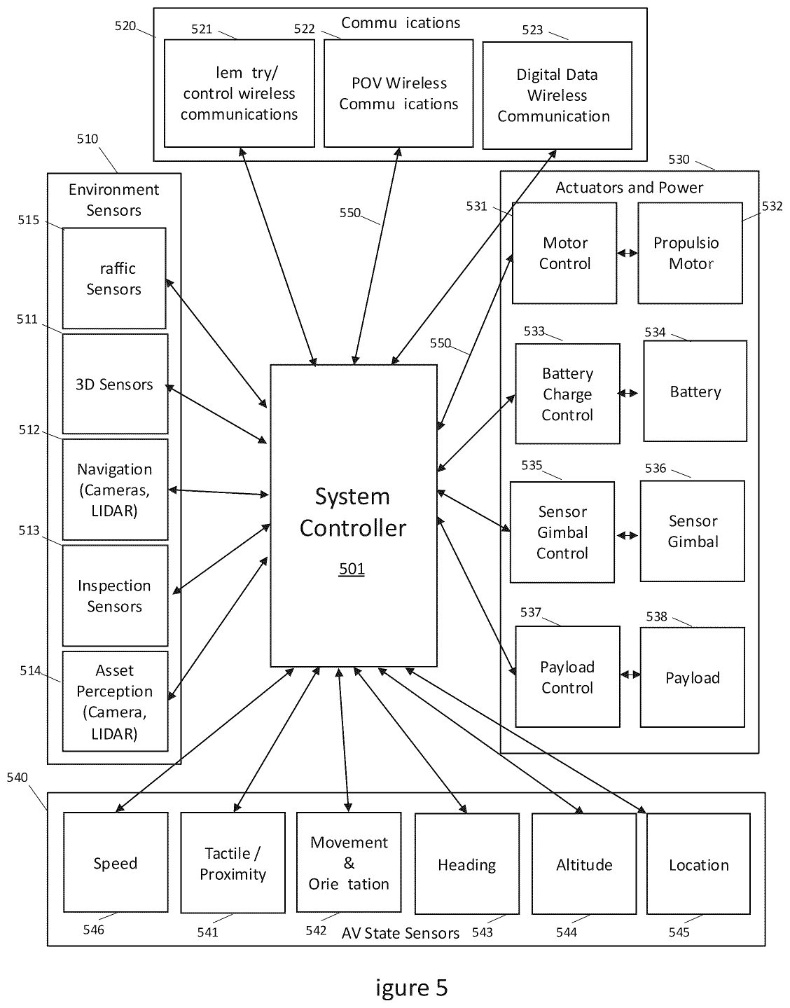

Referring to FIG. 1A, there is shown a method that generates a row-based world model for perceptive navigation of an autonomous vehicle (AV). The method operates with illustrative client devices 322 and 326, illustrative cloud station 328, and an illustrative AV tractor 302, which are described at FIG. 3 to FIG. 9 and related figures presented herein.

For the purposes of this patent, the term “AV cloud component” is referred to interchangeably as illustrative cloud station 328. Also, the AV cloud component may exist as an independent element or may be integrated with other cloud components or even local components, such as components on the AV or hardware and software components that are proximate to the AV.

In the illustrative embodiment, the row-based world model is generated by a farmer, a technician, or a field worker. The row-based world model and related mission plan can be generated when the hardware components and systems described herein are deployed. The row-based world model includes attributes and features that can be used to generate a mission plan that is downloaded to the AV on a mission-by-mission basis.

For example, the mission may be to find puddles, and the illustrative instruction from the farmer may be “Scout every row in this block and look for puddles and look for breaks in the water main.” Thus, the farmer's instruction gets translated to very specific AV instructions such as (1) go to row zero, and (2) go down the row and (3) turn around when the end of the row is reached.

The method 100 for generating a row-based world model is initiated at block 102 where an illustrative farmer accesses a mobile app with a map image using a client device 322 and/or 326. The client device receives a geocoded map image of a field from illustrative cloud station 328.

By way of example and not of limitation, FIG. 1B shows a screen capture 120 from the map that includes a field having a plurality of rows, in which each row further includes a plurality of plants. The screen capture 120 includes a “locate me” button 122 that performs the operation of locating the field and, thus, providing a general location for the field.

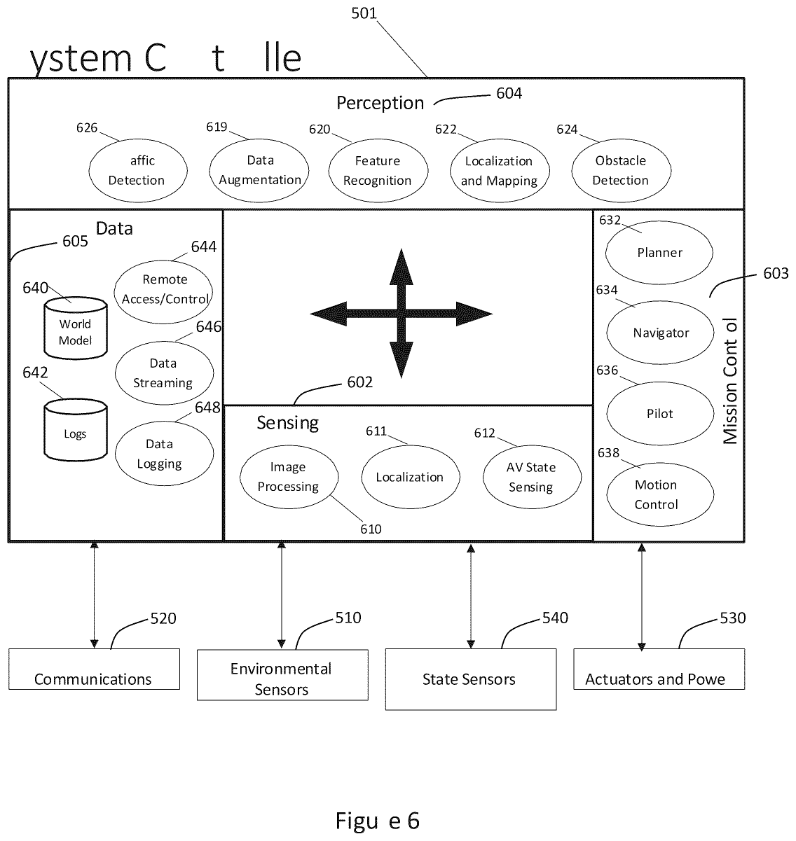

The map image presented in the screen capture 120 may be associated with a Google Earth™ image that includes a plurality of geocoded information. Google Earth™ enables users to search for specific places, navigate to desired locations, and explore the world based on addresses or geographic coordinates. An illustrative smartphone application may integrate with the illustrative Google Earth™ map image and gather geocoded information, which may be stored on the cloud station 328. In the illustrative embodiment, the cloud station 328 is communicatively coupled to the client devices 326 and 322 as described in FIG. 3 and FIG. 4.

Returning to block 104 where the geocoded map image information identified by the client device 322 and 326 is received by the AV cloud component, which may include a machine vision module which is also referred to as computer vision module. Also, the AV tractor may communicate with the client device and the AV tractor may perform the same or similar operations as the AV cloud component. Thus, the AV tractor may include an AV computer vision module and the AV cloud component software module.

By way of example and not of limitation, the AV cloud component operating separately from the AV tractor communicates with the client device 322 using a Wide Area Network (WAN) such as the Internet. WANs are susceptible to external threats, including unauthorized access, data breaches, and network attacks originating from external sources. WAN security often focuses on securing external connections, encrypting data over public networks, implementing firewalls, intrusion detection systems, and Virtual Private Networks (VPNs) to ensure secure communication between remote locations.

Additionally, the AV cloud component may be disposed on the AV tractor and the AV tractor communicates with the client device using a Local Area Network (LAN). LANs may face both external and internal threats, including unauthorized access from within the network, malicious activities by insiders, or local network-based attacks. LAN security may emphasize access control, user authentication, endpoint protection, and internal network segmentation to isolate and protect critical resources within the local network.

For purposes of this patent, an illustrative WAN embodiment is described in further detail. There are various benefits to the WAN embodiment, namely, the computationally intensive operations required by the systems and methods described herein can be transferred to a scalable cloud computing architecture that can adapt to changing processing and memory requirements. It should also be appreciated that those of ordinary skill in the art having the benefit of this disclosure can convert the WAN embodiment described herein to a LAN embodiment.

At block 106, the AV cloud component determines a perimeter for the field based on the map image and associated geocoded information. For example, the cloud station 328 includes a computer vision module or image processing module that detects the perimeter of the field from the map image.

Note, for the purposes of this patent the terms “computer vision module” and “image processing module” are used interchangeably, unless a separate meaning is intended. For example, reference is made to an image processing module being associated with cloud station 328, however, the term computer vision module is used more generally to apply operations performed at the AV 302 and cloud station 328.

By way of example and not of limitation, FIG. 1C shows an illustrative screen shot 130 of the field 132 having a coordinate 134. A “find boundary” button 136 causes the image processing module of cloud station 328 to detect the perimeter of the field from the map image.

In FIG. 1D, the resulting perimeter 142 generated by the computer vision module is shown at screen shot 140. The perimeter 142 generated with machine vision may then accepted by touching the “Accept” button 144. If the perimeter 142 generated by the computer vision module is not accepted, then the “Manual” button 146 is activated. In the illustrative embodiment, the manual button 146 enables the user to manually interact with a polygon geofencing software associated with the illustrative smartphone application running on the client device. Thus, the user can rely on machine vision or manual entry to define the perimeter 142. In FIG. 1E, the user saves the perimeter boundary 142 by touching the “Save Boundary” button 150.

At block 108, the AV cloud component determines a row distance between at least two rows. In the illustrative embodiment, the AV cloud component includes a computer vision module that detects the row distance between the rows. Additionally, the AV cloud component uses the computer vision module to detect an end for each row and a beginning for each row. Furthermore, the AV cloud component uses the computer vision module to detect the plant spacing between each of the plants in the row.

Referring now to FIG. 1F, there are shown a screen shot 160 that receives a variety of user inputs related to row spacing 162 and plant spacing 164. Generally, the user inputs provided for row spacing 162 and plant spacing 164 may be used to supplement or augment the results from the computer vision module.

At block 110, the AV cloud component determines a plant type for the plurality of plants. The plant type may be determined with machine vision or may be identified with a user input that is received by the illustrative mobile application.

At block 112, the AV cloud component determines an orientation for one or more rows. The orientation is relative to true North and includes the cardinal compass points that are from 0° to 360°.

At block 114, the cloud component then generates a row-based frame of reference, in which each row has an associated frame of reference that includes a distance. A location is determined based on a row number and the distance associated with the row number. In the illustrative embodiment, the cloud component generates a row-based world model with the row-based frames of reference. The cloud component also associates a semantic instruction with the row-based world model, and the cloud component communicates the row-based world model to the AV.

Referring to FIG. 1G, there is shown an illustrative row-based world model 170 that includes a plurality of rows, in which each row has a distance. A 2-D world model may be generated with the row-based frame of reference. Also, the illustrative farmer may generate a 2.5-D world model.

The 2-D world model and 2.5-D world model refer to different levels of perception and understanding of the vehicle's environment. In a 2-D perception system, the AV primarily relies on sensors such as cameras to capture visual information from the surrounding environment. The sensors provide a two-dimensional representation of the scene, capturing information about objects' positions and appearances on a flat plane. However, the perception is limited to the horizontal dimensions, lacking depth or vertical information. Objects are perceived as flat entities without a true sense of their height or elevation. An illustrative 2-D world model may be adopted for a field of crops that are close to the ground.

In a 2.5-D world model, depth or height is incorporated with the 2-D visual data. This depth information can be obtained using various sensors, such as lidar (Light Detection and Ranging) or radar. Lidar sensors, for example, emit laser beams and measure the time it takes for the beams to bounce back after hitting objects, providing a three-dimensional representation of the surroundings. By integrating depth information into the perception system, the vehicle gains a more accurate understanding of the scene, allowing for better object detection, localization, and mapping. An illustrative 2.5-D world model may be adopted for an orchard with trees or vines.

In operation, the illustrative farmer generates the row-based world model with the tractor, a rover, a quadcopter drone, or similar AV. For example, if the farmer needs to generate a 2-D or 2.5-D world model, a drone may be used to fly through a field of rows of trees or plants. The row-based world model does not consider whether the row is curved because of reliance on the row-based frame of reference. Thus, the tractor or drone follows the row since the plant or tree is organized around the row and the distance in the row. Additionally, the row-based world model may include at least one of an origin in the field, an entrance to the field, and an exit to the field. The row-based world model may also include a block or size of the field, the size or width of the rows, and the orientation of the row.

The row-based world model does not require surveying a row with latitudinal and longitudinal (lat/long) coordinates and establishing the lat/long coordinates for each object along the entire row. Generally, location implies a coordinate space (lat/long) as a “frame of reference,” which requires substantial resources when compared to the row-based frame of reference. The row-based coordinate includes an index number for each, e.g., the fifth row is a coordinate, and the length of the row is also a coordinate. In certain implementations, a marker may also be disposed in the row that indicates a particular frequency of rows or a particular row number, e.g., a marker may be at every fifth row. Simply put, the row-based world model does not require a resource intensive surveying process that is associated with lat/long coordinates. Thus, generating the row-based world model does not require any surveying equipment.

The simplified row-based world model is easier to generate and can receive semantic “row” based instructions such as “go to a particular row for a particular distance.” For example, the simple semantics or instructions may be “go to the third row and then go 30 meters.” With these semantic instructions, there is no need for lat/long coordinates. These semantic instructions are similar to instructions that may be given to a technician or field hand.

In a row-based world model, every row has its own frame of reference. Thus, it does not matter if the row is curving or going up and down a hill. In a row-based world model, instructions are simply based on the knowledge about a particular row. Instructions are given in these terms because they can operate with those semantics, which makes it much easier to generate a model of the world.

A row-based world model may also include the type of row or plant type, e.g., vine, orchard, etc. For example, vines are associated with a vineyard, almond trees are associated with an orchard. Although, these row-based models may operate using a similar 2.5-D world model, the perceptive navigation may operate differently because vines sit on a trellis and do not occupy the same space as an almond tree. Thus, perceptive navigation can operate differently based on plant type even if they share a similar 2.5-D world model.

The row-based world model may also include the separation of rows and depth of the row. Also, the row-based world model may include the individual plants in a row. For example, a particular vine may have a particular type of grape that regularly generates a particular volume of grapes during a harvest and each vine may have a particular value. Similarly, each tree may produce a certain amount of fruit and have a particular value.

Perceptive navigation with a row-based world model only requires an understanding of row and distance to provide a sense of location in the field. A row-based world model operates with a different frame of reference, where each row is a frame of reference-so the AV knows where it is based on the row it is in and the other rows around it; this is the benefit of perceptive navigation.

In operation, the systems and method described herein enable a farmer to take a map image of the farmer's field, draw a perimeter on the map of the farmer's field, and apply analytics that can identify the rows within the perimeter. If the map image is sufficiently accurate to determine the distance between rows, then a particular row can be identified using well-known computer vision tools. Additionally, the computer vision tools can be used to identify the beginning and end of a row.

Semantics may also be incorporated into how instructions are given to the vehicle to follow and how to localize the vehicle by creating individual plants and rows in the “world model.” This is the equivalent of “surveying.” The systems and method described herein overlay semantics on top of the world model to give meaning to a particular field. The farmer can generate instructions such as “drive along the row at a particular speed until the autonomous vehicle gets to the end of the row.” The end of a row may be defined by there being no more plants in the row. The next instruction may then include “when you get to the end of the row, turn around and go to the next row.”

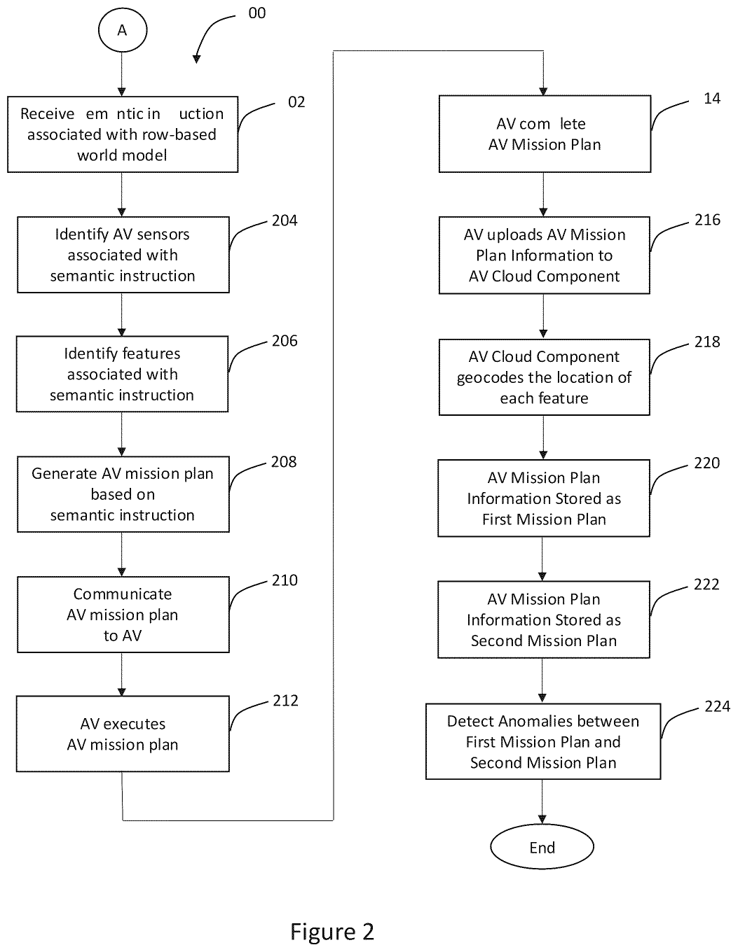

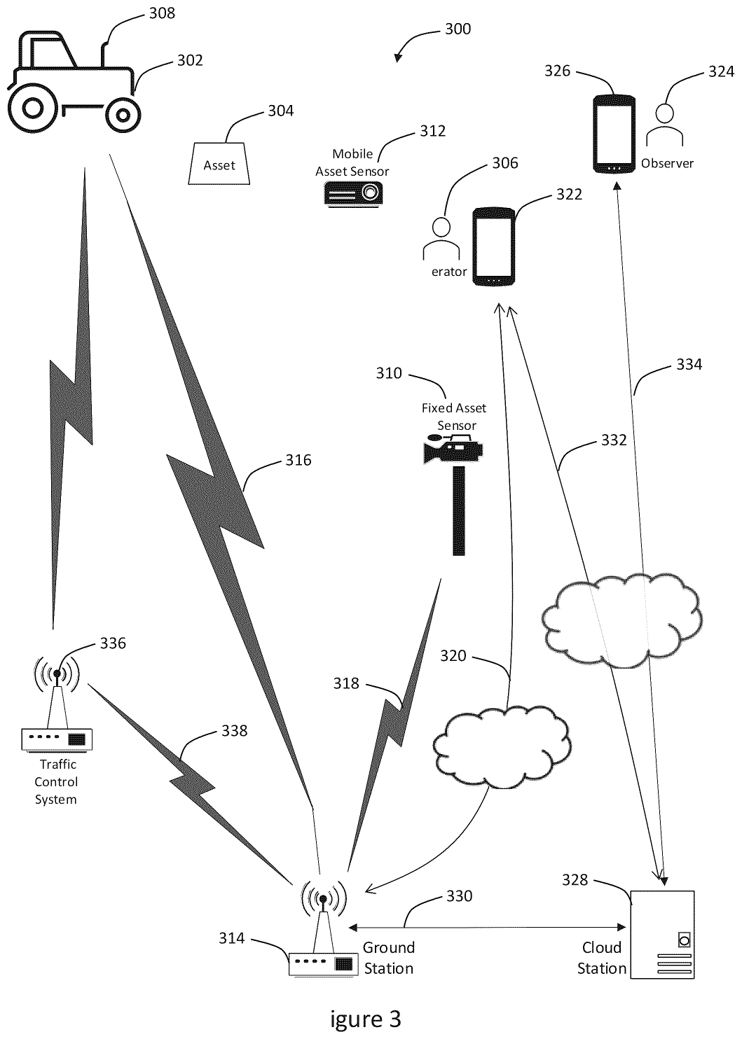

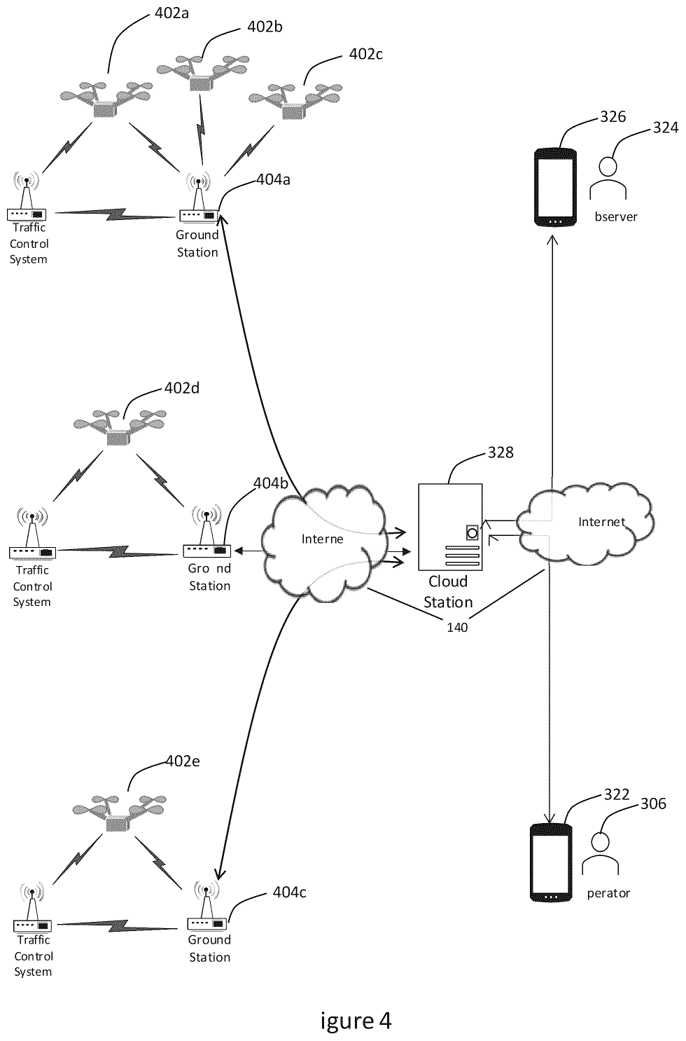

Referring to FIG. 2, there is shown a flowchart for a method of generating a mission plan with the row-based world model that was generated in FIG. 1A. Thus, the method 200 shown in FIG. 2 continues from the method 100 shown in FIG. 1A and is directed to a method for generating a mission plan for a field having rows of plants.

At block 202, a semantic user instruction associated with the AV mission plan is received. The semantic user instruction is associated with the row-based world model. The row-based world model enables a farmer to generate a mission plan using “high level words,” i.e., semantic user instruction, that is translated into more specific instructions that are passed to the AV at block 210. In the illustrative embodiment, the specific semantic instructions are not expressed in lat/long or x,y,z coordinates, but in the row-based semantics of row number and plant number.

In one illustrative embodiment, the semantic instruction is received by a client device that is communicatively coupled to one of the AV and the AV cloud component. In another embodiment, the AV cloud component identifies a configuration for each AV sensor that is associated with the semantic user instruction.

At block 204, AV sensors are identified that are associated with the semantic user instruction. In the illustrative embodiment, the AV cloud component identifies AV sensors associated with the semantic user instruction.

At block 206, features associated with the semantic user instruction are identified. More specifically, the AV cloud component identifies features associated with the semantic user instruction.

In the context of a mission plan for an autonomous vehicle (AV), a feature frame refers to a representation of specific features or characteristics of the environment that are relevant to the vehicle's perception and decision-making process. A feature frame is a way to describe and organize the salient attributes or elements of the environment that the AV needs to identify and respond to during its mission.

A feature frame typically includes information about the key objects, landmarks, obstacles, road infrastructure, and other notable elements in the AV's surroundings. It helps the AV's perception system understand and interpret the environment by providing a structured representation of relevant features.

The feature frame serves as a structured representation of the environment, allowing the AV's perception and decision-making systems to understand and reason about the relevant features during the mission. It helps the AV effectively perceive, interpret, and interact with the environment, enabling safe and efficient navigation and decision-making.

At block 208, the AV mission plan based on the semantic user instruction is generated. The AV cloud component generates the AV mission plan based on the semantic user instruction.

For example, if the illustrative farmer generates a mission plan to have an AV identify “puddles” by an AV tractor, then the AV tractor would use camera sensors to take pictures of the ground at the base of plants because the AV tractor is looking for leaks. The “find puddles” mission plan would be different from “find almonds” which would require looking “up” at the almond trees to find almonds. Although, the same illustrative camera sensors are being used, the mission plans are different because of the configuration of the camera sensors, e.g., the configuration for camera sensor points to the ground to locate puddles.

At block 210, the AV is communicatively coupled to the cloud component, receives the row-based world model, and receives the AV mission plan from the cloud component. For example, the AV mission plan includes the row-based world model, which is downloaded to the AV, so the AV has a world model with rows and plants and all the semantics for the rows and plants.

Creating a mission plan for an AV typically requires consideration of a variety of complex tasks. The specific details and complexities of mission planning for the AV may vary based on the vehicle's capabilities, intended application, and the operational environment. A general framework for creating a mission plan may be customized and refined according to the specific requirements and mission objectives of the autonomous vehicle system. Mission objectives may include determining what tasks the autonomous vehicle needs to perform, such as surveillance, mapping, or any other specific purpose.

Mission constraints may also form part of the mission plan. Mission constraints may include factors such as time constraints, weather conditions, vehicle capabilities, and safety considerations. Additionally, there needs to be an understanding of the potential obstacles, and any specific challenges or unique aspects of the area. Also, consideration must be given to waypoints and targets that may include areas to be surveyed or mapped.

Based on the mission objectives, environmental assessment, and waypoints, an optimal path is determined for the AV. Consideration must then be given to various safety requirements and corresponding safety measures incorporated, such as collision avoidance systems, obstacle detection, and emergency braking capabilities. Sensor data must then be integrated into the system and/or AV to inform the mission plan about object detection, localization, and environmental awareness.

The general framework for creating a mission plan includes decision-making algorithms and software systems that enable the AV to interpret sensor data, plan routes, and make real-time decisions during the mission. In view of changing conditions, certain factors such as obstacle avoidance, path planning, and dynamic decision-making must be considered. Further, the mission plan may continuously monitor the autonomous vehicle's performance during the mission and adapt the plan based on real-time feedback and sensor data. Continuous monitoring manages unexpected events, changes in the environment, or any other factors that require adjustments to the mission plan.

At block 212, the AV executes the AV mission plan using the row-based world model that is based on semantic instructions. In the illustrative “find puddle” mission plan, the AV travels down each row and collects information as still images or video with the camera sensor orientation pointing to the ground. As described in block 218, the still images or video may be geocoded based on row number and distance along said row.

At block 214, the AV completes the AV mission plan. In the illustrative embodiment, the information collected during performance of the mission plan by the tractor AV 302 (i.e., the tractor AV information) is collected from a memory card or automatically uploaded to cloud station 328.

At block 216, the AV uploads the AV information gathered from the AV mission plan to the cloud component. Thus, the illustrative search for puddles is completed offline and not performed in real time.

At block 218, the AV cloud component geocodes the location of each feature with a row-based frame of reference. Thus, each feature includes at least one row number and at least one distance associated with the row number. In the illustrative embodiment, additional analysis of the AV information occurs off the AV and a report is generated. The report may include the location of the puddles. This analysis may be performed with Artificial Intelligence (AI) algorithms or other sophisticated algorithms capable of analyzing the AV information.

At block 220, the AV information from the mission plan is stored in the AV cloud component. For illustrative purposes the AV information in block 220 is related to a first mission plan. By way of example and not of limitation, the first mission plan includes the semantic user instruction for the field and the AV mission plan information collected from the one or more sensors at a first time.

An illustrative first mission plan may be a “scouting” mission, in which the illustrative AV tractor traverse the field and drives down each row grabbing information and looking for something specific, e.g., leaks in pipes or tubing. Thus, a scouting mission can search for puddles and find leaks in pipes or tubing. For purposes of this patent, “scouting” refers to the gathering of AV information for the whole field and analyzing information for the field. Simply put, scouting refers to gathering AV information. The illustrative AV tractor and/or AV drones are “scouting” when gathering AV information. Note, the system and methods presented herein are not limited to scouting and may also include interactions with actuators that can spray a plant or engage a picker.

At block 222, the AV mission plan information from a second mission is also stored in the AV cloud component. In the illustrative embodiment, the AV mission plan information includes the semantic user instruction from the second exploratory mission plan, which occurs at a second time. The AV mission plan information also includes the gathered sensor information from the same sensors that was collected at the second time.

At block 224, the AV cloud component then identifies one or more anomalies by detecting differences between the sensor information gathered during the first exploratory mission plan and the second exploratory mission plan. Thus, anomalies refer to the detection of changes to the field since the previous scouting mission. For example, a fallen tree that was recently detected on the most recent scouting mission would be considered an anomaly. Anomaly detection can be expanded to include other changes in the field that can be detected by comparing images gathered at different times.

Referring to FIG. 3, there are shown illustrative main architectural components for AV system 300 that supports perceptive navigation of an AV tractor 302. More generally, the apparatus, systems, and methods described herein relate to the navigation of AVs, especially as it pertains to navigating with respect to an asset feature. By way of example and not of limitation, an AV can move within its environment and perform certain tasks either with or without direct control by humans. An AV may execute an overall mission plan by using the systems, methods, and apparatuses described herein.

An AV may be a tractor, a land vehicle, an air vehicle, a sea vehicle or any combination thereof. An AV may have the ability to propel itself and move within its environment. Also, the AV may have the ability to operate autonomously, i.e., in a self-governing manner. The AV may be controlled directly or indirectly by a human operator. Additionally, the AV may have the ability to determine trajectories and achieve various objectives that may be specified as part of a mission using perceptive navigation, as discussed in detail below. Further, the AV may have the ability to interact with its environment, e.g., interact with other AVs or with people. Furthermore, the AV may have the ability to sense its environment to determine objects within its vicinity. Further yet, the AV may have the ability to perceive, i.e., recognize specific objects within its environment.

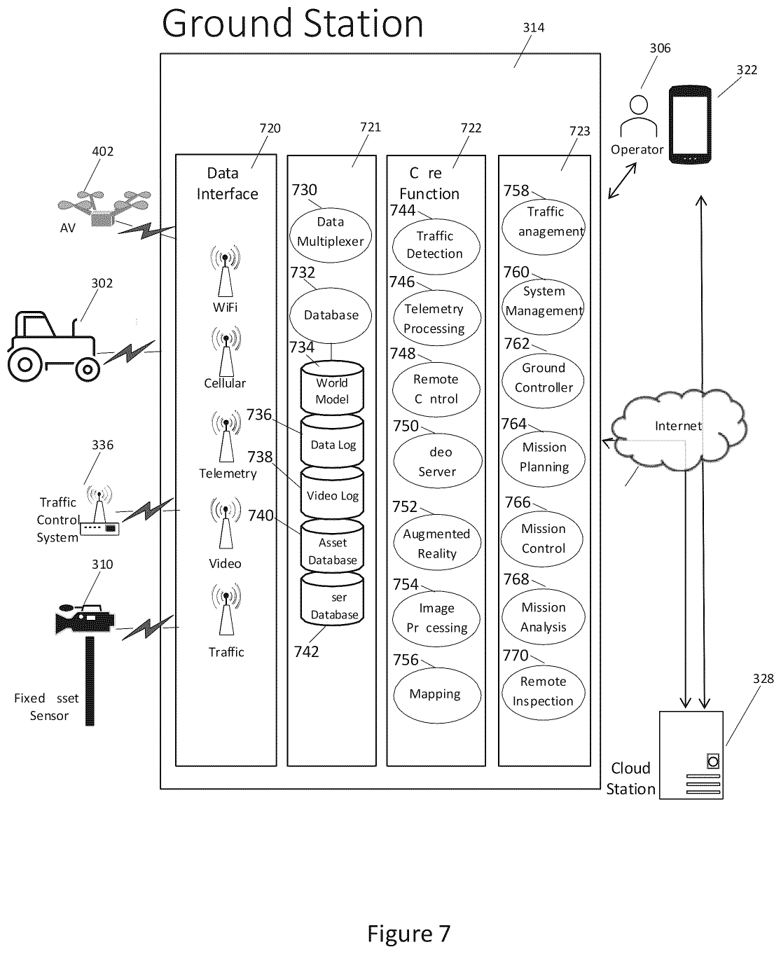

An asset feature is anything within the vicinity of the AV that can be detected and recognized by the AV. Such objects or features can include markers or specific pieces of equipment. As further non-limiting examples, an agricultural asset feature may include crop rows in a field, warehouse asset features may be pallet racks, beams, and columns, and bridge asset features may be beams, girders, corridors, faceplates, joints, cables, and plates. As described further below, there are various subsystems involved in perceiving these various features. The AV uses readily available sensors such as cameras, LIDAR, etc. and well-known computer vision algorithms to detect and locate the AV with respect to the asset features. Asset features are, therefore, used to perform perceptive navigation, as described further below in FIG. 7.

From a communications perspective, the tractor AV 302 may have the ability to communicate with human operators and observers in real time and to send various types of information to the human operators and observers. The AV information that is sent may include the AV state, such as a location, the AV's operational state, environmental sensor information, such as video streams, and AV data store information, such as system logs, data logs, and an AV world model. The AV may also receive information, such as AV control commands, updates to various AV operational parameters, and updates to various AV data stores, such as the AV's row-based world model.

In the illustrative embodiment, the “state” information includes velocity, acceleration, and the relative position of the AV 302 to nearby entities, such as the ground or objects in proximity to the AV 302.

FIG. 3 shows an illustrative AV 302 as a tractor. In the illustrative embodiment, there is an illustrative asset 304 within the operational vicinity of the AV 302. In general, asset 304 has two properties, an identity and location. Thus, the AV 302 can correctly identify the asset 304 and the AV 302 can determine the location of the asset. In the illustrative embodiment, the asset 304 may be of interest to an illustrative AV operator 306.

By way of example and not of limitation, the asset 304 may be a row, a plant, a tree, a stationary structure, a stationary natural element, a mobile man-made device, e.g., a car, a mobile natural element, e.g., a bird, or any other such stationary or mobile assets. Stationary structures may include crops, bridges, buildings, warehouses, equipment or any combination thereof. An illustrative mobile natural element may include animals, e.g., a bird, a dog, sheep, cattle, or wild animals such as deer, bison, or bears within the vicinity of AV 302. Additionally, there may be more than one asset 304 in a location. In some instances, the AV 302 may interact with and manipulate the asset 304, which may include another AV, a person, a sign or other such asset.

In operation, the AV 302 can sense and perceive the asset 304 through one or more sensors 308. The illustrative sensor 308 may be selected from a group of sensors that include an RGB camera, a sonar sensor, a LIDAR sensor, an infrared sensor and other such sensors. In general, the sensor 308 performs two functions, namely, enabling the AV 302 to distinguish the asset 304 from the surrounding AV environment by recognizing the asset 304 and enabling the AV 302 to perceive specific features corresponding to the asset 304 by recognizing those specific features.

Additionally, the illustrative AV system 300 may include a fixed asset sensor 310 operating near the AV 302. The illustrative fixed asset sensor 310 is not mobile and provides yet another device to identify asset features and track asset features within the vicinity of the AV 302. The fixed asset sensor 310 can sense and perceive the asset 304 with fixed asset sensing capabilities.

The AV system 300 may also include a human operator 306 that can operate the tractor AV 302. The operation of the AV 302 may include performing AV management, mission planning, mission control and/or mission analysis. AV management relates to the general maintenance and servicing of the AVs. Mission planning refers to the activities the AV is required to perform during the “mission,” especially as it pertains to the collection of information associated with the asset 304.

For the embodiments presented herein, mission planning includes the act of defining the activities corresponding to the mission. Mission control refers to the monitoring and control of the AV 302 during its mission. Mission analysis refers to the analysis of the AV mission after the AV mission has been completed. Mission analysis includes the review and analysis of any data collected by the AV 302 during the mission.

In operation, the operator 306 interacts with the AV 302 from a location that is either near the AV 302 or remote to the AV 302. Operator 306 may have access to a mobile asset sensor 312 that enables the operator to identify features on the asset 304. Like the AV 302 and the fixed asset sensor 310, the mobile asset sensor 312 includes mobile asset sensing capabilities that operate with a variety of different apparatus, algorithms and systems. The mobile asset sensing capabilities enable the mobile asset sensor 312 to identify the asset 304 and features corresponding to the asset 304. As described in further detail below, the identified features are associated with a particular asset, that asset's location, and an orientation with respect to that asset.

The AV system 300 also includes a ground station 314, which provides a range of functionality including communicating wirelessly 316 with the AV using illustrative communication systems or standards including, but not limited to, Wi-Fi, cellular, or other analog or digital communications technologies. The type of information communicated between the AV and ground station 314 includes telemetry information from the AV 302, mission and control information to the AV 302 and application specific information such as video or images from the AV 302.

The ground station 314 also communicates with the fixed asset sensor 310 and may receive, by way of example and not of limitation, videos or pictures captured by an illustrative camera sensor 310. By way of example and not of limitation, communications 318 between the ground station 314 and the fixed asset sensor 310 may use standard wireless communication technologies or wired communication standards such as Ethernet, RS485 standards, or other similar technologies.

In the illustrative embodiment, asset 304 information is communicated to ground station 314. In some embodiments, the ground station 314 operates as a communications bridge between AV system 300 components. For example, there may be software applications running on station 314, which may be accessed directly by operator 306 using a communications channel to communicate with the ground station 314. The operator 306 may also access data or applications on the ground station 314 using a remote communication channel 320 that is communicatively coupled to a Wide Area Network (WAN), e.g., the Internet, a cellular network or any combination thereof. A user interface 322 associated with a computing device may be used to remotely access the ground station 314. The computing device may include, by way of example and not of limitation, a cell phone, a tablet, a desktop computer and a laptop computer.

In another illustrative embodiment, an observer 324 may remotely access information from the AV 302 using a Wide Area Network (WAN), e.g., the Internet. More specifically, the observer 324 interacts with an illustrative user interface device 326, such as a smartphone or laptop running a mobile application having an associated user interface. The information accessed by the observer 324 may include AV data, e.g., camera images and videos, and application specific information associated with an asset or asset feature.

The AV system 300 may also include a cloud station 328 that is communicatively coupled to the ground station 314 with communication channel 330. Cloud station 328 includes web-based interfaces that are accessible by operator 306, using communication channel 332, and observer 324, using communication channel 334. Cloud stations may contain many of the same applications associated with ground station 314.

The AV system 300 may also include a traffic control system (TCS) 336 that communicates with the AV 302 and/or the ground station 314 along communication channel 338. The illustrative TCS 336 controls the traffic of other AVs (not shown) in its vicinity. By way of example and not of limitation, a TCS may include a camera system for image detection, a storage device for the detected images, and an object detection algorithm. Detected images may be analyzed to determine the number of vehicles detected in all directions.

Referring to FIG. 4 there is shown an illustrative embodiment having a plurality of aerial quadcopter AVs 402a, 402b, 402c, 402d, and 402e communicating with a plurality of ground stations 404a, 404b, 404c. Cloud station 328, presented in FIG. 3, may be accessed by a plurality of observers 324 and a plurality of operators 306. The illustrative cloud station 328 provides a centralized integration point for information exchange with the observers 324 and operators 306. Additionally, cloud station 328 aggregates the information from other AVs and ground stations. By way of example and not of limitation, the cloud station stores images, video, location, trajectory, mission plans, AV sensor data and other such information.

Referring to FIG. 5 there are shown the various AV subsystems corresponding to the illustrative AV 302. The illustrative AV 302 includes a variety of different subsystems such as a system controller 501, a communications module 520, an environmental sensor subsystem 510, an AV state sensor subsystem 540, and actuator and power components 530. Additionally, the AV 302 includes a mechanical frame (not shown) configured to provide a suitable platform for the hardware and software comprising the various subsystems shown in FIG. 5. Furthermore, the AV 302 includes a plurality of system controller interfaces 550 for the various components of each subsystem using standard interfacing means such as various CPU busses, and serial or parallel communications devices and protocols including, but not limited to SPI, CAN, RS485, USB, I2C, Ethernet and other such communications devices and protocols.

The communications subsystem 520 manages and controls all the communications between the AV 302 and other systems or components outside, or not residing on, the AV 302. Since the AV 302 is principally in a mobile state, the communications subsystem 520 is primarily wireless and uses a variety of standard wireless technologies and protocols including, but not limited to, Wi-Fi, cellular, or other analog or digital communications suitable for the type of data being communicated.

The communications subsystem 520 communicates telemetry and control information 521, point of view sensor information 522, and high bandwidth digital data information 523, each on respective communications channels. More specifically, telemetry and control information 521 may include a telemetry and control information channel used to communicate telemetry and control information 521 associated with AV 302. By way of example and not of limitation, the telemetry information includes any AV state information ranging from sensor values to vehicle parameters and state. The “state” may include inputs that are stored as variables or constants, in which the variables stored in memory can also change.

The telemetry and control information channel may also be used to send control information to the AV such as motion commands and mission plan parameters. Additionally, the telemetry and control information channel may also be used to transmit local traffic control information. In general, telemetry and control information 521 transmitted over the telemetry and control information channel includes data points or packets that are not very large, so lower bandwidth wireless communications technologies may be used for the telemetry and control information channel, such as Zigbee, Bluetooth Low Energy (BLE), Low Range Wide Area Network (LoRaWAN), Narrowband IoT (NB-IoT), Wireless Local Area Network (WLAN), and other comparable lower bandwidth wireless communications technologies.

The communications subsystem 520 also communicates point of view (POV) sensor information 522 along a point of view (POV) channel. The POV sensor information 522 communicates information associated with the POV sensor, e.g., camera, sensing the environment surrounding the AV 302. The POV sensor information 522 is transmitted or communicated to the ground station 314, the cloud station 328 or any combination thereof. By way of example and not of limitation, the POV sensor information 522 includes imaging data and/or video data captured by a camera disposed on the AV 302. The camera disposed on AV 302 provides operators 306 and observers 324 with AV generated POV sensor information 522 of a mission. Typically, the POV channel transmits analog video data. By way of example and not of limitation, the POV sensor information 522 transmitted along the POV channel includes remote surveillance video that is viewed by the operator 306 or observer 324. The communications subsystem 520 may also include digital data information 523 transmitted along a digital communications channel (i.e., Wi-Fi, 4G LTE, 5G, Satellite, Point-to-Point Microwave Links, Wireless HDMI, and other comparable higher bandwidth wireless communications technologies), which is a general communications channel that supports higher bandwidth digital data and may be used to transmit any type of information including Telemetry/Control and POV images.

The actuator and power subsystem 530 include one or more components that are used for actuating and powering the AV 302. Actuators (not shown) disposed on the AV 302 enable the AV 302 to move within and interact with the AV's environment. The actuators are powered by various subsystems of the AV 302, which include motor controllers 531, propulsion motors 532, a sensor gimbal control 535, a sensor gimbal 536, payload control 537, a payload 538, battery charge control 533, and a battery 534.

The illustrative motor controllers 531 and propulsion motors 532 enable the AV 302 to move within its environment. In the case of a rotary aircraft this might include motors that drive propellers, and in the case of a land-based vehicle this might include motors for the drive wheels and steering mechanism. The motor controller 531 receives motion and attitude commands from the system controller and translates those commands into specific motor instructions for the various motors designed to cause the AV to comply with the motion and attitude commands.

The sensor gimbal control 535 and sensor gimbal 536 are used to control the orientation of one or more environmental sensors, e.g., cameras. Sensor gimbal control 536 receives sensor attitude commands from the system controller 501 and translates those attitude commands into motor commands designed to cause the sensor gimbal to orient in a manner complying with the sensor attitude commands.

The payload control 537 is used to control any payload 538 the AV 302 may be carrying. Control of a payload 538 can include picking up and/or dropping payloads 538. The payload control 537 receives commands from the system controller 501 concerning payload disposition and translates those commands into the appropriate corresponding actuation of the payload control.

In some embodiments, the various systems on the AV 302 are electric and require some sort of battery 534 to provide power during remote operation. Battery charge control 533 subsystem controls the charging of the battery 534 and provides information to the system controller 501 concerning the state of the battery 534.

The illustrative system controller 501 provides the main subsystem responsible for processing data and providing control functions for the AV 302. The system controller subsystem 501 is described in further detail in FIG. 6.

The AV state sensor subsystem 540 allows the AV 302 to sense its own “state.” For the illustrative AV 302, the “state” of the AV 302 is expressed as a position and orientation (also termed a “positional pose”) in three-dimensional (3-D) space. The “positional pose” includes the attributes: six degrees of freedom (6DOF), three positional coordinates and three rotational coordinates (orientation) around each spatial axis. In the illustrative embodiment, the “state” of the AV can further include a velocity, acceleration, and the relative position of the AV 302 to nearby entities, such as the ground or objects in proximity to the AV 302.

The “frame of reference” is a coordinate system that provides context for the position and orientation coordinates of the positional pose. In the illustrative AV embodiment, the positional pose of the AV is an attribute of the AV and serves to specify the location of the AV (position and orientation) within a “frame of reference.” The “frame of reference” is specified by a coordinate system (e.g., polar, Cartesian, etc.), units for the coordinates (e.g., meters, radians, etc.), and a system for specifying the direction of rotation around each axis (i.e., right hand rule).

An asset is a physical entity that has features identifiable by an AV. The asset can be man-made, e.g., a bridge or building. The asset can also be natural, e.g., a row of crops and/or plants. The position of an asset may be referenced by its distance from a fixed point of reference.

An asset feature may include a unique identifier, size, dimensions, center point, color and texture characteristics, topological data, and other such properties. For example, an edge profile for each asset may be identified from the captured images. The profile may be compared to a database of predetermined asset features to identify a match for asset classification. Proximity between assets or asset features can be used to classify the asset as being of a predetermined asset type.

The illustrative AVs described herein are configured to recognize an asset, asset feature or the combination thereof. The perceptive navigation systems and methods described herein may be used to navigate with respect to the recognized asset and/or asset feature, even in the absence of a known location for the asset and/or asset feature, GPS guidance, or other conventional navigation tools.

In operation, an AV positional pose is identified that includes an AV position in three-dimensional space and an AV orientation in three-dimensional space. A frame of reference is associated with the AV positional pose, in which the frame of reference includes a coordinate system for the AV position and the AV orientation. A localization module determines the AV positional pose with respect to the corresponding frame of reference. A feature is detected in an AV environment with an environmental sensor. An Asset Feature Frame (AFF) defines the AV positional pose with respect to the feature in the AV environment and the AV positional pose is determined by the environmental sensor.

In the illustrative embodiment presented herein, the AV navigation can employ one or more frames of reference, including a fixed geo-reference frame (GRF), fixed local frames (LCF), and relative body frames (RBF). The geo-reference frame (GRF) provides the location of the AV with respect to the surface of the earth, i.e. a sphere. The fixed local frames (LCF) provide a cartesian coordinate space that may be mapped to the GRF through a transform. However, in many instances a transform from an LCF to the GRF may not exist.

The relative body frame (RBF) provides a cartesian coordinate space having an axis aligned with the body of the AV. Also, the RBF may have the Cartesian coordinate space aligned with the major axis of the body of the AV. The RBF alignment depends on the symmetry and shape of the AV body. The RBF coordinate space moves with respect to the LCF and GRF as the AV moves through the LCF and GRF.

In some embodiments, there may exist multiple instances of the LCF and RBF and so there may be numerous transforms between the various LCFs and RBFs. For example, each asset of interest can have its own LCF, each AV sensor (e.g., camera) can have its own RBF with a transform between the sensor RBF and the AV's RBF. More specifically, each LCF frame of reference may be uniquely identified, e.g., LCF-1 and LCF-2.

The AV state sensor subsystem 540 includes speed sensors 546, tactile/proximity sensors 541, movement/orientation sensors 542, heading sensors 543, altitude sensors 544, and location sensors 545. Speed sensors 546 measure the speed of the AV 302 using air speed indicators or encoders on wheels. The tactile/proximity sensors 541 include by way of example but not of limitation, sonar, infrared, ranging (LIDAR) sensors, RADAR, and other light detection sensors.

The tactile/proximity sensors 541 indicate the proximity of the AV 302 to barriers, obstacles, and the ground. The movement/orientation sensors 542 determine the movement and orientation of the AV 302 through sensors including accelerometers and gyroscopes. Accelerometers and gyroscopes are generally integrated together in an Inertial Measurement Unit (IMU). The heading sensors 543 determine the heading of the AV 302 within an environment, typically the environment of the AV 302. The heading sensors 543 determine the heading of the AV 302 within an environment using electronic/digital compass technology. The altitude sensors 544 include barometers, ranging technology (e.g., ultrasonic and laser range finders), and stereo cameras. The altitude sensors 544 employ barometers to determine a mean sea level (MSL), and stereo cameras or ranging technology to determine an above ground level (AGL). The location sensors 545 determine the location of the AV 302 within its environment, and a Global Positioning System (GPS) or other system based upon beacons placed within the environment.

The environmental sensor subsystem 510 allows the AV 302 to sense its environment. The various functions of the environment sensor subsystem 510 disclosed herein may be implemented using any one of the sensors disclosed or any combination thereof. For example, the environmental sensor may be a single camera that may be used to implement more than one of the functions described herein. The environment sensor subsystem 510 can include 3-D sensors 511, navigation sensors 512, inspection sensors 513, asset perception sensors 514, and traffic sensors 515.

The 3-D sensors 511 sense and create 3-D profiles of the objects around the AV 302. In some embodiments, the 3-D sensors create depth maps and “point clouds” within the field of view of the sensors. A “point cloud” is a set of points in 3-D space with respect to the AV's location and corresponds to the known location of an object. The 3-D sensor can be Light Detecting and Ranging (LIDAR), sonar, stereo cameras, range sensors (e.g., infrared, ultrasonic, laser), RADAR, or any combination thereof. The 3-D sensors can perform a variety of functions including asset perception, obstacle avoidance, navigation, location, and mapping.

The navigation sensors 512 ensure that the AV 302 is accurately and safely following the trajectory that the AV 302 is attempting to navigate by localizing the AV 302 within a frame of reference. As stated above, the navigation sensors can include any one or combination of the 3-D sensors 511 and can also include other sensors that detect and recognize certain landmarks within the AV environment. For illustrative purposes, landmarks may include visible fiduciary markers, such as April tags that may be placed at specific locations within the environment.

Inspection sensors 513 capture relevant information pertaining to an asset 304 that is under inspection by the AV 302. Inspection sensors 513 can be autonomous or manually operated by an operator 306. Inspection sensors 513 can include cameras operating in the visible spectrum, infrared, ultraviolet, multi-spectral, and any combination thereof. As stated above, the inspection camera can be the same camera used for navigation. The inspection sensors 513 can include cameras that capture images, which are used remotely by the operator 306 and observer 324 as part of a mission.

The asset perception sensors 514 identify specific features of an asset 304 in the AV environment. By way of example but not of limitation, the asset perception sensors 514 may employ machine vision. In some embodiments, the asset perception sensor 514 is identical to the sensor used to collect 3-D information or navigation data. The traffic sensors 515 sense vehicle traffic near AV 302 and may be embodied as a transponder that facilitates communications, a camera with machine vision, lidar, radar, etc.

Referring now to FIG. 6, there is shown a detailed block diagram of the system controller 501. The system controller 501 interfaces with several subsystems of the AV 302 including the communications subsystem 520, the environmental subsystem 510, the AV state sensor subsystem 540, and the actuator and power subsystem 530. The system controller 501 can be implemented using standard processors and off-the-shelf electronics. The system controller 501 can utilize a readily available operating system such as Ubuntu or the Robot Operating System (ROS), to manage the various tasks and software running on the system controller 501.

The software functionality of the system controller can be partitioned into the following groups: sensing 602, perception 604, mission control 603, and system data management 605. The sensing functionality 602 of the system controller 501 is responsible for the system controller's 501 capability to sense various elements, both the system controller's own state and the state of the environment.

The sensing functions performed can include image processing 610, localization 611, and AV state sensing 612. Localization 611 is the act of locating AV 302 within a frame of reference outside the AV 302. The system controller 501 receives inputs from one or more sources including an AV state sensing module, a feature recognition module 620, and a localization and mapping module 622.

In one embodiment, the system controller 501 receives input from a GPS, and calculates the AV location in an Earth frame of reference. In another embodiment, the system controller 501 receives input from multiple sensors, such as an IMU and visual odometer, and fuses the various measurements. In still another embodiment, the system controller 501 performs a simultaneous localization and mapping (SLAM) process, in which the AV 302 is localized with respect to objects within its environment from data received from environmental sensors. In an exemplary embodiment, a landing pad is the asset feature identified, and the AV 302 is localized with respect to the landing pad. In another exemplary embodiment, beacons can be installed in the AV environment to enable performance of triangulation or trilateration to localize the AV 302 with respect to the beacons.

Image processing includes the process of taking images from one or more environment sensors, e.g., cameras, and processing the images to extract useful information. The extraction function generally includes various low-level filters, transforms, and feature extractions performed on the images. Extraction can be performed using readily available software, such as OpenCV or OpenVX.

AV state sensing 612 is performed by one or more of a variety of sensors that measure the state of the AV 302, as described above. In one embodiment, AV state sensing is performed with input received from a GPS, in this embodiment little additional processing is required to use the GPS data input.

In other embodiments, AV state sensing 612 is performed with input received from sensors that require additional processing of the sensor data for the AV state information to be readily usable by the other subsystems; this additional processing can include filtering and sensor fusion between multiple sensors. Sensor fusion aids in the reduction of error characteristics. Different sensors used for localization have different error characteristics that are minimized by the localization module through sensor fusion using techniques such as Extended Kalman Filters (EKF) to fuse the locations generated by different sensors. Sensor fusion increases the accuracy of the location in a particular frame of reference. A well-known example is the fusing of measurements from an IMU with GPS readings using an EKF.

The perception functionality 604 of the system controller 501 is responsible for the system controller's 501 ability to recognize and categorize the various elements and states sensed by the AV sensors. The perception functions performed can include data augmentation 619, feature recognition 620, localization and mapping 622, obstacle detection/recognition and tracking 624, and traffic detection 626. Data augmentation 619 is the act of generating and adding additional visual information to images and video that can be streamed to operator 306 or observer 324. In some embodiments, data augmentation 619 can include the addition of labels or other data superimposed on images or video.

Feature recognition 620 employs machine perception to identify and track known features of assets 304 and the environment around the AV 302 from processed images. Generally, feature recognition 620 provides input to the process of localization 611.

The localization and mapping functions 622 include localizing the AV 302 in the world and can also include updating a row-based world model of the AV 302. The row-based world model of the AV 302 is updated from data received by the environment sensors. In some embodiments, readily available SLAM and visual odometry techniques are employed to update the world model. The localization and mapping functions 622 provide input to the process of localization 611 and play a role in perceptive navigation.

Obstacle detection/recognition and tracking 624 relates to detecting obstacles within the field of view of AV 302. The obstacle detection/recognition and tracking 624 process identifies physical objects that may impact the performance of the AV 302 during a mission. However, the obstacle detection/recognition and tracking 624 process need not identify what the obstacles are, and therefore can use simpler sensors and techniques than those employed for perceptive navigation. Traffic detection 626 relates to the function of detecting other vehicle traffic in the vicinity of the AV 302.

Mission control functionality 603 of the system controller 501 relates to the execution of a mission plan and the management of various AV activities during the mission that are collectively termed mission objectives. The mission plan may include a set of tasks, such as, route planning, navigation, en route actions, payload management, and en route data acquisition. Data acquisition may be logged and/or streamed to the ground station 314 in real time. Mission control functionality 603 operates hierarchically through a planner 632, a navigator 634, a pilot 636, and a motion controller 638.

Planner 632 generates instructions aimed toward the achievement of mission plan objectives. Mission objectives to be achieved by the AV 302 include dates/times for achieving those mission objectives. In one embodiment, the AV 302 is an aerial AV and the associated mission objectives include one or more flight plans and actions to be taken by the aerial AV along a flight path described by the one or more flight plans. Thus, the flight plans are instructions that control the motion of the aerial AV and the actions correspond to instructions for non-motion related activities, such as “take pictures” during one or more flight plans or along the flight path. The motion related instructions can include a trajectory. A trajectory is defined as a flight path constructed from a sequence of maneuvers within a frame of reference. Traditionally a flight path was defined as a sequence of poses or waypoints in either a fixed geo-reference frame (GRF) or a fixed local frame (LCF). However, perceptive navigation allows trajectories to be defined using coordinates in Asset Feature Frames as well.

Navigator 634 performs the motion related instructions specified by planner 632. Navigator 634 receives the mission objectives from planner 632 and generates a set of instructions that achieve those mission objectives. The navigator 634 then tracks the AV's 302 progress on the mission objectives. In one embodiment, the mission objectives include a trajectory for the AV 302 to follow. In this embodiment, the navigator 634 translates the trajectory into a sequence of maneuvers to be performed by the AV 302. The navigator 634 generates maneuver instructions for the pilot 636. Maneuvers can be predefined actions that the AV can execute, including launch, land, orbit a point, follow a feature, and follow a trajectory.

Pilot 636 performs and is responsible for position control of the AV 302 through the generation of motion commands. Additionally, pilot 636 is responsible for collision avoidance. Pilot 636 receives maneuver instructions from the navigator 634, executes an action corresponding to a maneuver instruction, and attempts to achieve the maneuver instruction. In some embodiments, motion commands generated by the pilot 636 are within a frame of reference. In other embodiments, maneuver instructions require a detailed model of the AV 302 for proper execution by pilot 636.

The motion controller 638 performs low level closed loop control in order to execute commands received from the pilot 636. The motion controller 638 receives commands from the pilot 636 and performs actuation of the AV 302. In some embodiments, the motion commands received from pilot 636 include velocity or attitude commands.

In addition to information flowing from the planner 632 to the navigator 634 to the pilot 636 as discussed generally above, information can also flow from the pilot 636 to the navigator 634 to the planner 632. In an exemplary embodiment, this flow of information represents feedback, such as whether tasks or mission objectives have been achieved. If mission objectives are not achieved, the planner 632, the navigator 634, and the pilot 636 can take appropriate responsive actions to alter or change the mission, the flight plan, or one or more objectives. Exemplary scenarios that can cause the planner 632, the navigator 634, or the pilot 636 to alter or change one or more mission objectives include: unforeseen obstacles, vehicle traffic near the AV 302, any inability to perform one or more objectives or tasks, or a malfunction related to one or more systems or subsystems of the AV 302. Note, traffic control may require an AV's mission control subsystem 603 to coordinate actions with a third-party traffic control system.

The system data management functionality 605 of the system controller 501 includes storing a variety of information onboard the AV 302 (i.e., data stores) and various data management tasks. Data stores on the AV 302 can be implemented in a variety of standard manners and forms including databases and file systems.

The data stores on the AV 302 include row-based world model 640. As described previously, the row-based world model 640 is a representation of the environment that the AV 302 operates within. The world model 640 can include a two-dimensional (2-D) map, a 2.5-D map, and/or a 3-D map database of the AV's environment. The row-based world model 640 can also include a model of the AV itself, including the AV's operational capabilities and constraints or limitations.

Additionally, the data stores of the AV 302 include data logs 642. The “logs” 642 act as the receptors of data that the AV generates or collects. The logs 642 can include AV state information, system operation logs, and sensor data, such as images and video.

The data management tasks include remote access/control 644, data streaming 646, and data logging 648. Remote access and remote control 644 tasks include the management of data originating from the AV, which include remote control commands or data, and parameters that are sent to the AV. Data streaming 646 tasks include the streaming of data to the ground station 314. Streamed data can include telemetry data, images, and video. Data logging 648 tasks include logging data to the AV data stores.

Referring now to FIG. 7, there is shown an illustrative ground station 314 and the ground station functions 722. The illustrative ground station 314 is communicatively coupled with the tractor AV 302, the aerial AV 402, traffic control system 336, and the fixed target sensor 310. Additionally, ground station 314 is communicatively coupled with operator 306 and the cloud station 328.

The illustrative ground station 314 operates using a central processing unit (CPU), memory and various communications technologies. By way of example and not of limitation, the ground station 314 may include a data interface 720, ground station data management module 721, a core functions component 722, and applications module 723. However, in some embodiments, the ground station 314 may perform more limited functions and include a communications hub for communicating with an AV 302. In addition to storing data, the ground station 314 routes data between the various components such as the fixed sensor 310, the AV 302, the operator 306, the cloud station 328, and the UI device 322. In some illustrative embodiments, data routing may be a dedicated function performed by the ground station 314.

The data interface 720 provides communication services to the tractor AV 302, the aerial AV 402, and the fixed asset sensor 310. The communications services may include wireless communications utilizing wireless technology, such as Wi-Fi, cellular, low bandwidth telemetry communications channels, analog video communications and other such communication services. In some illustrative embodiments, the data interface may provide a wired connection to the ground station 314 that utilizes Ethernet, USB, or other similar technologies.

The ground station data management module 721 manages a wide range of data. In the illustrative embodiment, the ground station 314 data management module 721 includes a data multiplexer 730 and a database 732 with a file system. For example, the data stored in the ground station may include data for a world model 734, a data log 736, a video log 738, an asset database 740, a user database 742 and other such systems, components and modules configured to store and/or process data. In addition to the storing of the data described herein, ground station 314 handles routing data between various components and in certain circumstances the ground station 314 only performs the routing of data.

As described above, the world model 734 associated with the ground station 314 provides a representation of the environment that the AV 302 operates within. The row-based world model 734 can include a two-dimensional (2-D) map database of the AV's environment, a 2.5-D map database, and/or a 3-D map database of the AV's environment. The world model 734 can also include a model of the AV itself, including the AV's operational capabilities and constraints or limitations.

Data logs 736 associated with the ground station 314 store telemetry from the AV and system operation logs. Video logs 738 include image data, video data or the combination thereof that are streamed from the AV and stored by the ground station 314. The illustrative asset database 740 stores attribute information of various assets that interface with the ground station 314, including the tractor AV 302, aerial AV 402 and other such devices. The user database 742 stores operator information.

The core functions 722 performed by the ground station 314 can include traffic detection 744, telemetry processing 746, remote control 748, video server management 750, reality augmentation 752, image processing 754, and mapping 756. Traffic detection 744 relates to the function of detecting other vehicle traffic near AV 302. Another illustrative core function 722 of the ground station 314 includes processing all telemetry information 746 received from the AVs in preparation for either logging the data or providing the data to the operator 306 or observer 324 as part of a mission plan.

The other core functions 723 performed by the ground station 314 include a remote control core function 748 which allows an operator 306 to remotely control the AV 302. The ground station 314 may also perform a video server core function 750, in which servers are used to stream images and video received from the AV 302 to operators 306 and observers 324. Another core function performed by the ground station 314 includes augmented reality 752, which relates to the process of superimposing additional information on images and video received from an AV 302 to aid operators and observers with viewing and reviewing the images and video.

Yet another core function performed by the ground station 314 includes image processing 754, in which images are taken from one or more environment sensors, e.g., cameras, and processed to extract useful information. The extraction process generally includes various low-level filters (i.e., Gaussian Blur, Median Filter, Laplacian of Gaussian (LoG), Histogram Equalization, etc.), transforms (i.e., Sobel Operator, Discrete Fourier Transform (DFT), Color Space Transformations, etc.), and feature extractions (i.e., Canny Edge Detection, etc.) performed on the images. More specifically, the extraction process may be performed using readily available software, such as OpenCV or OpenVX.

Still another core function performed by the ground station 314 includes the mapping core function 756, which includes updating the world model based on data received from the AVs. In some embodiments, the mapping core function includes compiling the output of the AV's localization and mapping process into a centralized world model for all AVs.

Various of the core functions 722 of the ground station 314 support applications 723 that can be used by the operator 306 or the observer 324. These applications 723 can include, but are not limited to, traffic management 758, system management 760, ground controller 762, mission planning 764, mission control 766, mission analysis 768, and remote inspection 770. The traffic management application 758 includes the process of coordinating the movements of AVs near the ground station 314 to ensure safe operation of all vehicles in a vicinity of the ground station 314; safe operation includes collision avoidance and vehicle movement optimization through coordinating the movements of one or more AVs. The system management application 760 manages various physical components including AVs, ground stations, docking stations, etc. The system management application 760 further manages the configuration of these various physical components. The ground controller application 762 can be used by an operator 306 to control and monitor one or more AVs. The mission planning application 764 can be used by operator 306 in preparation for an AV mission to plan activities, tasks, objectives, or actions to be performed by an AV during the mission. These activities, tasks, objectives, or actions can include inputting waypoints, inputting areas, locations, assets, or asset features for inspection, image capture, video capture, and other such activities. The mission control application 766 executes and monitors a mission being performed by an AV 302. Mission monitoring includes monitoring various AV state information and allowing operators 306 or observers 324 to view streams of images and/or video from the AV 302; and the mission control application 766 can include some remote control of the AV and input from an operator. The mission analysis application 768 analyzes a mission after completion of the mission; and the mission analysis application 768 can further replay various telemetry data streams collected during the mission. The remote inspection application 770 allows for the viewing of streams of images and/or video from the AV by operator 306 or observer 324; and this viewing can be provided in real time or replayed after a mission is completed.

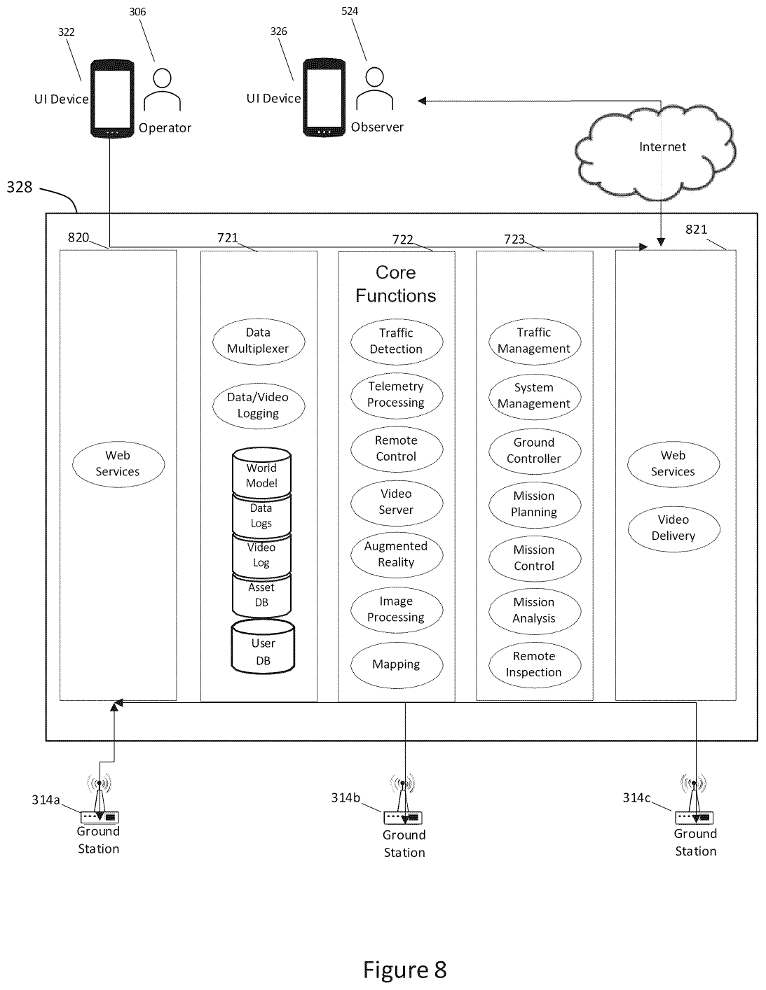

Referring now to FIG. 8, there is shown the various functions of the cloud station 328. Cloud station 328 is designed to interface with one or more ground stations 314a, 314b, 314c, one or more operators 306, and one or more observers 324. As with the ground station 314, the cloud station 328 can include data management 721, core functions 722, and applications 723. Thus, these functions can exist in the ground station 314, the cloud station 328, or both.

Cloud station 328 interfaces with one or more ground stations 314a-c through a web services interface 820. The web services can be implemented using standard methodologies, such as SOAP, REST, JSON, and other such web services. The web services 820 implement standard web-based security mechanisms. Cloud station 328 can provide the same functions as the ground station 314. In certain embodiments the cloud station 328 interfaces with multiple ground stations 314, and thus aggregates information from the multiple ground stations 314. Cloud station 328 may be configured to provide a web-based interface to operators 306 and observers 324, so that operators 306 and observers 324 can utilize web-based UI devices 322 and 326, respectively. The web-based interfaces utilize standard methodologies and web-based user applications. The cloud station 328 is configured to be implemented through computer servers having a processor and memory, including virtual servers available from various service providers.

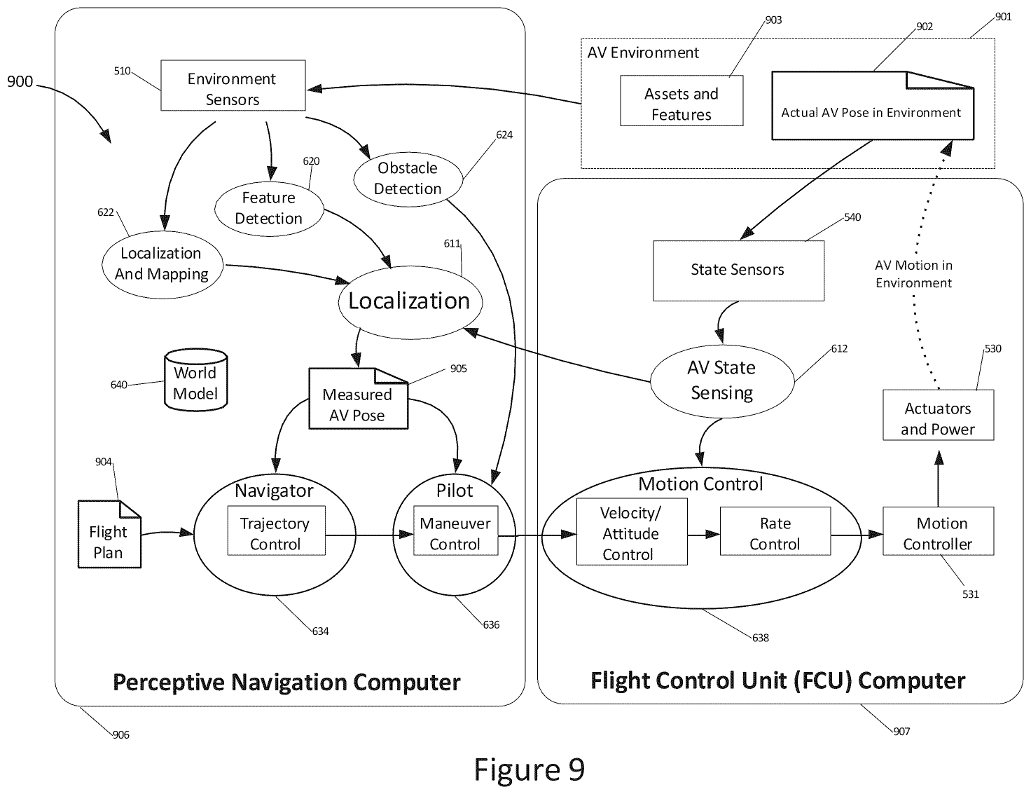

Referring now to FIG. 9, there is shown a flow chart depicting a perceptive navigation control loop 900. In the illustrative embodiment, the perceptive navigation control loop 900 is a closed loop control system that includes a desired trajectory, described by a flight plan 904 through state space, which is represented by a reference frame.

As discussed above, the AV navigation may employ one or more frames of reference including a fixed geo-reference frame (GRF), fixed local frames (LCF), and relative body frames (RBF). Perceptive navigation employs a further type of reference frame, namely, an asset feature frame (AFF). As previously stated, an asset feature frame (AFF) defines the AV positional pose with respect to the feature in the AV environment and the AV positional pose is determined by the environmental sensor.

In the illustrative embodiment, the flight path of the AV is specified in terms of known features 903 perceived with feature detection 620 by the AV environmental sensors 510 as opposed to simple coordinates as is typically done when specifying a flight plan and performing navigation. The AV's current state, e.g., positional pose 902, and actual trajectory in the state space are determined from sensor measurements of asset features having known locations, GPS, or other similar technologies. In the case of asset feature measurement, the sensor measurements are processed by a localization module 611 with respect to some specific known asset feature having a location and measured orientation in the AV environment to produce a measured AV pose 905.

Therefore, perceptive navigation is differentiated from existing techniques such as SLAM, in which navigation is typically performed in a fixed coordinate frame and any features in the environment that are perceived by the AV are mapped to that coordinate frame.

In operation, the navigator 634 receives the measured AV pose 905 and compares the measured AV pose 905 to the trajectory to produce a course correction that directs the AV towards the flight plan trajectory. Pilot 636 receives the course correction and determines the requisite maneuver(s). Motion control module 638 receives the maneuvers and determines the requisite motor control instructions for the various motors and actuators of the AV. The motor controller 531 receives the motor control instructions and activates the actuators and motors 530 accordingly.

Additionally, the motor controller 531 compares the actual trajectory of the AV in the state space to the desired trajectory and adjusts the motion of the AV in order to bring the measured or perceived trajectory of the AV as close as possible to the desired trajectory and pose determined from the flight plan 904.

As described above, the AV includes environmental sensors 510, which are used to perceive objects, such as assets and asset features, within the environment. As depicted in FIG. 9, the output of the environmental sensors 510 is used for localization and mapping 622, feature detection 620, and obstacle detection 624. The localization and mapping module 622 and the feature detection module 620 provide input to the localization module 611.

Additionally, there exist state sensors 540 that can measure the state of the AV in its environment. These sensors are used by the AV state sensing module 612 to derive the AV state. The AV state is used by the localization module and the motion control module 638.

The localization module 611 fuses together the various sources of location information and forms a measured AV pose 905. The location information includes GPS, Inertial Measurement Unit (IMU) and other such apparatus, systems and methods that provide location information. The illustrative AV pose is used by both the navigator 634 and the pilot 636 to navigate the AV along a trajectory described by the flight plan 904.

As shown in FIG. 9, navigator 634 uses flight plan 904 to specify an intended trajectory of the AV. Perceptive navigation provides a system and method that manages how the AV executes “follow trajectory” maneuvers specified by a flight plan. More specifically, the perceptive navigation closed loop control system determines a measured or actual AV pose from a sensor measurement of an asset feature in a frame of reference that can be an AFF, a GRF, a LCF, or RBF.

Thus, the navigations system may further include a trajectory in a flight plan 904, in which the coordinates of the trajectory are expressed with the frame of reference and the AFF. The perceptive navigation method may further receive a trajectory in a flight plan 904, at the perceptive navigation subsystem 906, wherein the coordinates for the trajectory are expressed with the frame of reference and the AFF. Also, the navigation system may include a trajectory in a flight plan 904 received by the perceptive navigation system wherein the coordinates for the trajectory are expressed with the frame of reference and the AFF.

The various functions depicted in FIG. 9 are implemented as software modules on a processor that interfaces with various sensors and actuators. In FIG. 9 these software modules are depicted as operating on two separate hardware subsystems, namely, the Perceptive Navigation computer subsystem 906 and the Flight Control Unit (FCU) computer subsystem 907. The Perceptive Navigation computer subsystem 906 interfaces with the various environment sensors described herein. Each environmental sensor input performs the perceptive navigation tasks as described herein. The FCU computer system 907 interfaces with the actuators and performs all the low-level motion control functions of the AV. The Perceptive Navigation computer subsystem 906 exchanges information with the FCU computer subsystem 907.

The FCU computer subsystem 907 communicates AV state information to the Perceptive Navigation computer subsystem 906. The Perceptive Navigation computer subsystem 906 communicates motion control commands to the FCU computer subsystem 907. By way of example and not of limitation, the illustrative FCU computer subsystem 907 and the Perceptive Navigation computer subsystem 906 are associated with system controller 501, which may be embodied as one or more standard processors and off-the-shelf electronics, as described herein.

The perceptive navigation subsystem 906 determines an AV positional pose 902 based on the AV state information. The AV positional pose 902 includes an AV position and an AV orientation in three-dimensional space. A frame of reference is associated with the AV positional pose 902 by the perceptive navigation subsystem 906. The frame of reference includes a coordinate system for the AV position and the AV orientation. A localization module 611, corresponding to the perceptive navigation subsystem 906, determines the AV positional pose 902 and the corresponding frame of reference. The environmental sensor 510 detects a feature in an AV environment 901. The asset feature frame (AFF) associates the AV positional pose 902 with the feature in the AV environment 901. The perceptive navigation subsystem 906 identifies the AFF. Also, the perceptive navigation subsystem 906 generates a motion control command based on the AV positional pose 902 and the AFF. The motion control command is then communicated to the FCU subsystem 907 that controls the AV movement.

In the illustrative embodiment, the AV positional pose 902 is determined by the environmental sensor 510, which is associated with the perceptive navigation subsystem 906. Additionally, the environmental sensor 510 is selected from a group of sensors that consist of a camera, a navigation sensor, an inspection sensor, an asset perception sensor, a traffic sensor, a Light Detecting and Ranging sensor, a sonar sensor, a stereo camera, an infrared range sensor, an ultrasonic range sensor, a laser sensor and a RADAR sensor. In a further illustrative embodiment, a system controller is disposed on the autonomous vehicle, in which the system controller 501 includes the FCU subsystem 907 and the perceptive navigation subsystem 906.

There are various types of asset feature frames (AFFs) depending upon how many degrees of freedom (DOF) the AFF has and the geometric attributes that define the features of the AFF. The AFF sub-types can include vector to plane with no orientation (AFF-PLO), vector to plane with two-dimensional (2-D) orientation (AFF-PL2), vector to plane with 3-D orientation (AFF-PL3), vector to line with no orientation (AFF-LN0), vector to line with 3-D orientation (AFF-LN3), vector to point with no orientation (AFF-PT0), and vector to point with 3-D orientation (AFF-PT3).

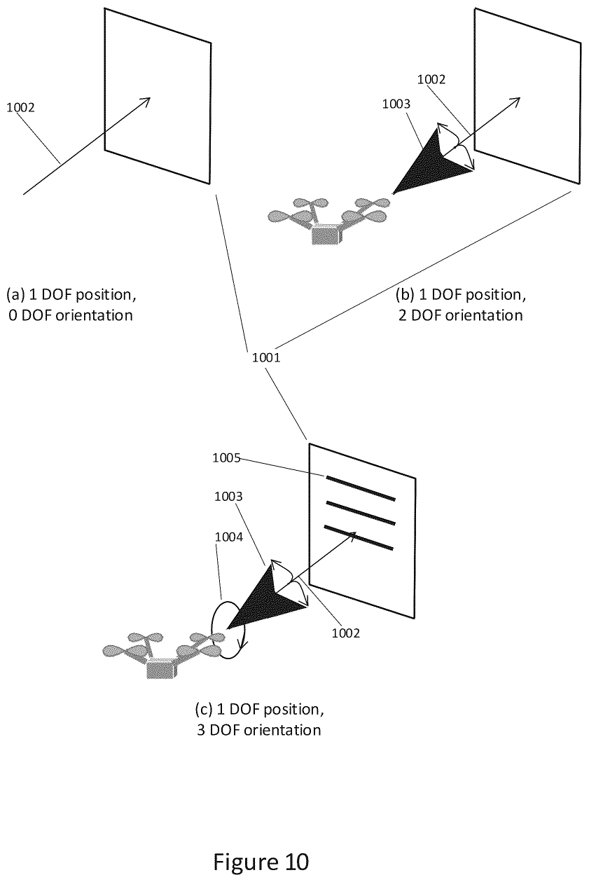

Referring now to FIG. 10, there are shown three AFF sub-type examples and their associated DOFs for both position and orientation: (a) 1 DOF for position and 0 DOF for orientation, (b) 1 DOF for position and 2 DOF for orientation, and (c) 1 DOF for position and 3 DOF for orientation. In example (a), a vector frame of reference 1002 perpendicular to a planar feature 1001 from the AV. The position of the AV is only known to have one degree of freedom, which is the extent of the AV's distance from the planar feature 1001. However, the orientation of the AV with respect to the plane is not known in this frame of reference, and thus has zero degrees of freedom in that regard. A further example of an AV coordinate within an AFF-PLO frame of reference is the AV's altitude above ground, in which the ground is the planar feature. The AV's location in the AFF-PLO frame of reference may be determined by using some sort of ranging sensor to determine how far away the AV is from the ground.

In example (b), there is shown the same frame of reference as in example (a), AFF-PLO, except that the orientation 1003 of the AV with respect to the planar feature 1001 is also known (i.e., roll and pitch with respect to the vector 1002 perpendicular to the planar feature 1001), making this the AFF-PL2 frame of reference. However, the orientation 1003 is only known to two degrees of freedom. The orientation of the AV, i.e., yaw, around the vector perpendicular to the plane is not known. An exemplary AFF-PL2 frame of reference may be provided from sensors that determine both the distance to the ground and the orientation of the AV with respect to the ground. In the example, distance to the ground and the orientation of the AV with respect to the ground could be determined from a downward pointing sensor, i.e., a stereo camera, that provides a depth map from which the distance to the ground plane and the orientation of the ground plane with respect to the AV could be determined.

In example (c), there is shown the same frame of reference as in examples (a) and (b), except that the orientation of the AV with respect to the planar feature 1001 is known to three degrees of freedom, making this the AFF-PL3 frame of reference. In addition to orientation 1003 (i.e., roll and pitch with respect to the vector 1002 perpendicular to the planar feature 1001), the orientation 1004 of the AV around the vector 1002 perpendicular to plane 1005 is also known. An exemplary AFF-PL3 could be provided from sensors that provide both the distance to the ground and the orientation of the AV with respect to the ground. In the example, the additional orientation 1004 can be determined from a pattern on the ground plane that yields an orientation to the ground plane with respect to the AV.

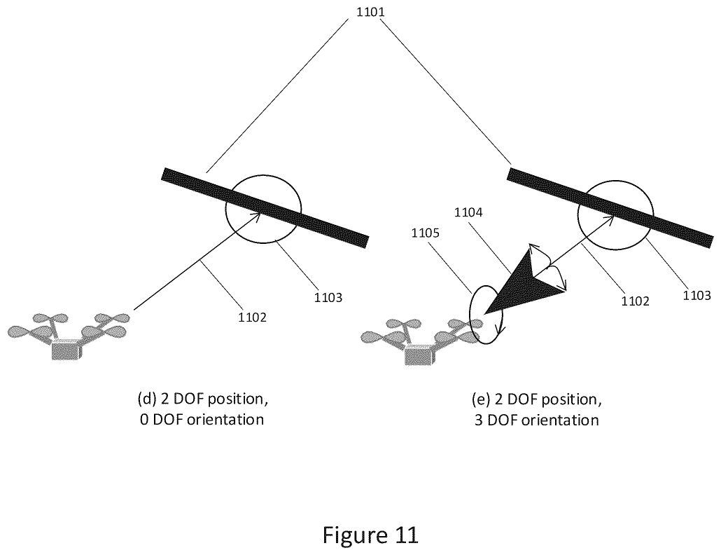

Referring now to FIG. 11, there are shown two further AFF sub-type examples and their associated DOFs for both position and orientation: (d) 2 DOF for position and 0 DOF for orientation, and (e) 2 DOF for position and 3 DOF for orientation. In example (d), a vector to line with no orientation (AFF-LN0), in which the vector of the AV is associated with a linear feature 1101. In the AFF-LN0 sub-type, the vector is perpendicular to the linear feature, allowing determination of the position of the AV to only two degrees of freedom, namely the distance 1102 to the linear feature 1101 and the polar coordinate 1103 representing the angle between the line 1102 from the AV to the linear feature 1101. The orientation of the AV with respect to vector 1102 is not known in this frame of reference and thus has zero degrees of freedom.

In example (e), there is shown a vector to line with 3-D orientation (AFF-LN3). In the AFF-LN3 sub-type, where the vector 1102 is the same as that shown in example (d), except that the orientation of the AV with respect to the linear feature is known to three degrees of freedom. In example (e), the roll and pitch orientation 1104 of the AV with respect to the vector 1102 to the linear feature 1101 and the yaw orientation 1105 of the AV about the vector 1102 to the linear feature 1101 are known.

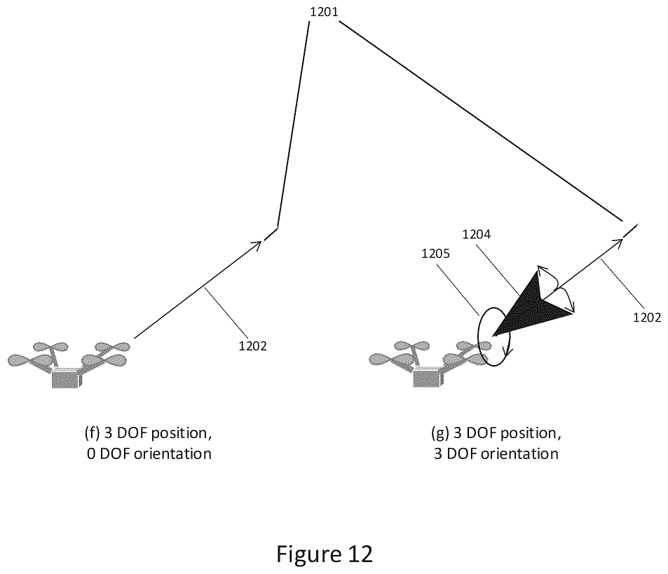

Referring now to FIG. 12, there are shown two further AFF sub-type examples and their associated DOFs for both position and orientation: (f) 3 DOF for position and 0 DOF for orientation, and (g) 3 DOF for position and 3 DOF for orientation. In example (f), the 3 DOF for position and 0 DOF for orientation arises from a vector to point with no orientation (AFF-PT0). In the AFF-PT0 sub-type, vector 1202 of the AV is associated with a point feature 1201. In the AFF-PT0 sub-type, the position of the AV is known to three degrees of freedom with respect to the point feature. However, the orientation of the AV with respect to the point feature is not known and has zero degrees of freedom.

In example (g), the 3 DOF for position and 3 DOF for orientation arise from a vector to point with 3-D orientation (AFF-PT3). In the AFF-PT3 sub-type, the same vector 1202 as in example (f) is shown, except that the orientation is also known to three degrees of freedom, roll, pitch, and yaw.

There may or may not be transforms between the AFFs described above and a fixed local frame (LCF). If there is a transform between an AFF and a LCF, then the features that are used to generate the location within the AFF may be fixed or static. Also, the features may be moving with respect to a LCF and so moving the transform from the AFF to the LCF is dynamic.

Referring back to FIG. 9, the act of the AV determining its position is termed “localization.” When the AV employs perceptive navigation, the AV uses machine vision techniques to perceive known features of its environment to aid in the navigation process. In the illustrative embodiment, the AV operates and moves within an environment 901 that includes assets having perceivable features 903. Additionally, the AV has an actual state within the environment represented in FIG. 9 as 902.

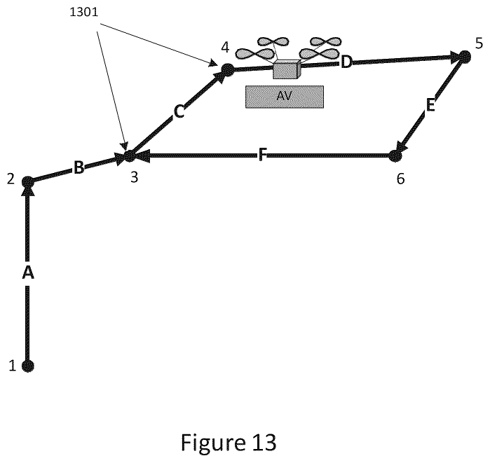

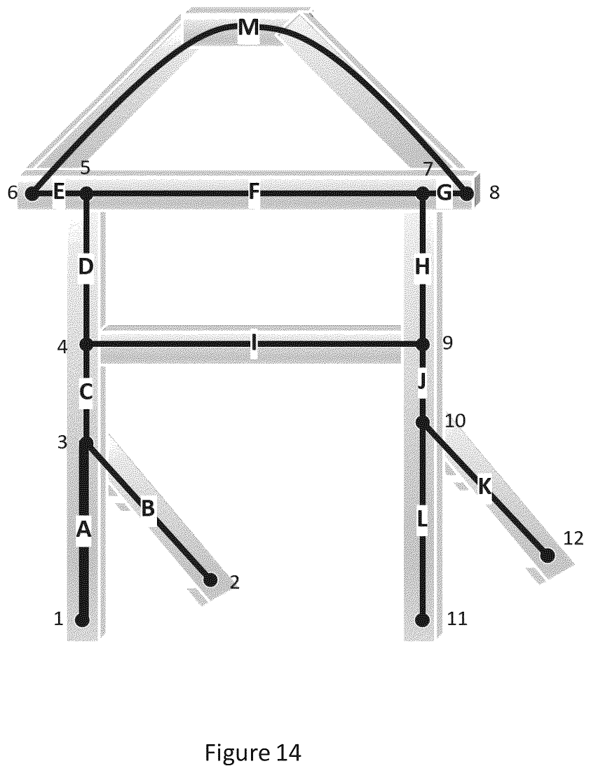

Referring now to FIG. 13, there is shown an illustrative trajectory in a fixed geo-reference frame (GRF), in which each maneuver A through F is simply a straight-line path between GPS waypoints 1301. Perceptive navigation allows trajectories to be defined using coordinates in asset feature frames (AFFs). Additionally, perceptive navigation allows for the trajectories to be composed of multiple complimentary frames of reference.

In an illustrative embodiment, a trajectory is composed of a sequence of waypoints in a GRF that includes latitude and longitude coordinates with heading. The AV travels between waypoints using the GRF with the added constraint that the AV maintain a certain altitude above ground level associated with AFF-PLO as described above. Thus, the AV is navigating using AFF-PLO and the feature of interest in the AFF-PLO is the ground. In the illustrative embodiment, when pilot 636 executes this maneuver, the AV would use two coordinates from the GRF location and one coordinate from the AFF-PLO to navigate in 3-D space.

Regardless of the frame of reference used, the basic task in following a trajectory is to compare the AV's current pose to that of the trajectory in the appropriate frame of reference. Subsequently, flight control commands are issued so that the AV's pose will match that of the trajectory as closely as possible. The trajectory following task does this iteratively, maneuver by maneuver, measured pose by measure pose, until the entire trajectory is traversed and completed.

Referring now to FIG. 14, there is shown an illustrative model of an asset that includes features A through M. Each feature of the asset model can have one or more attributes including a unique identifier, a feature type, an AFF classification, dimensions, a pose within other frames of reference, and a topological relationship to other features in the asset. Additionally, each feature of the asset can have one or more predefined paths that the AV can take when flying with respect to that feature.

Each of the paths associated with a feature must satisfy certain requirements. Firstly, under normal circumstances each path must be a safe trajectory for the AV to traverse. Secondly, each path must place the AV in an appropriate perspective to collect data concerning the asset. Thirdly, the asset feature must be in view of the AV so that the AV can continue to use the asset feature for localization purposes, except for brief periods of time. Fourthly, each path must provide sufficient connectivity with paths to adjacent features of the asset. These four requirements are intended to be non-limiting and in no particular order. In FIG. 14, the paths travel through the nodal positions 1 through 12 so that features A through M will be observed, sensed, and measured by the AV traveling between the nodal positions 1 through 12.

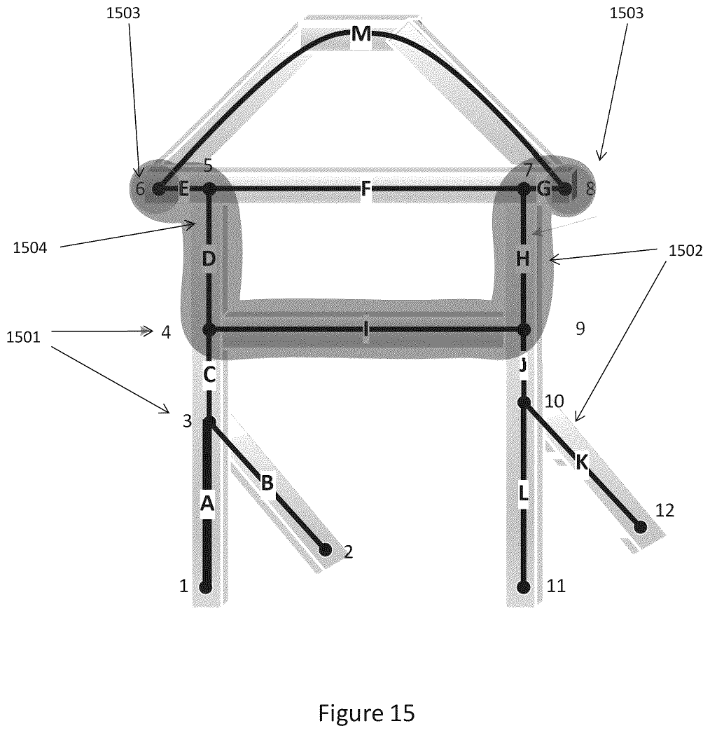

Referring now to FIG. 15, there is shown a traversability graph (TG) representing the connectivity between asset features and an exemplary path 1504 through the TG that consists of edges E-D-I-H-G. The TG generally depicts a network of paths that the AV can traverse when moving with respect to the asset. The TG in FIG. 15 includes features such as edges 1502 (i.e., H and K) and nodes 1501 (i.e., 4 and 3) that provide connections between certain or all of features A through M. FIG. 15 shows how route planning using the TG becomes a simple graph search since the paths associated with each feature are pre-determined. In addition to nodes 1501 and edges 1502, a TG may also include entry/exit points 1503 (i.e., 6) that are predetermined locations in the TG, in which the AV can enter or exit the paths in the TG.

It is to be understood that the detailed description of illustrative embodiments is provided for illustrative purposes. Thus, the degree of software modularity for the transactional system and method presented above may evolve to benefit from the improved performance and lower cost of the future hardware components that meet the system and method requirements presented. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A method for generating a row-based world model for perceptive navigation of an autonomous vehicle (AV), the method comprising:
receiving, at a client device, a map image of a field having a plurality of rows, in which each row includes a plurality of plants;
determining, at a cloud component, a perimeter for the field;
determining, at the cloud component, a row distance between at least two rows;
determining, at the cloud component, a plant type for the plurality of plants;
determining, at the cloud component, an orientation for one or more rows;
generating, at the cloud component, a row-based frame of reference, in which each row has an associated frame of reference that includes a distance, wherein a location is determined based on a row number and a distance associated with the row number;
generating, at the cloud component, a row-based world model with the row-based frame of references;
associating, at the cloud component, one or more semantic instruction with the row-based world model; and
downloading, from the cloud component, the row-based world model to the AV.

2. The method of claim 1 wherein the cloud component includes a computer vision module that detects the perimeter of the field from the map image.

3. The method of claim 1 wherein the cloud component includes a computer vision module that detects the row distance between the at least two rows.

4. The method of claim 1 wherein the cloud component includes a computer vision module that detects an end of each row and a beginning of each row.

5. The method of claim 1 wherein the plant type is determined from a user input.

6. The method of claim 1 wherein the row-based world model includes a plant height and the cloud component generates a 2.5-D world model that includes a plant height.

7. The method of claim 1 wherein the row-based world model includes a 2-D world model having a plurality of horizontal information gathered from the map image.

8. A system for generating a row-based world model for perceptive navigation of an autonomous vehicle (AV), the system comprising:
a client device that receives a map image of a field having a plurality of rows, in which each row includes a plurality of plants;
a cloud component communicatively coupled to the client device, wherein the map image identified by the client device is received by the cloud component;
the cloud component determining a perimeter for the field;
the cloud component determining a row distance between at least two rows;
the cloud component determining a plant type for the plurality of plants;
the cloud component determining an orientation for one or more rows;
the cloud component generating a row-based frame of reference, in which each row has an associated frame of reference that includes a distance, wherein a location is determined based on a row number and a distance associated with the row number;
the cloud component generating a row-based world model with the row-based frames of reference;
the cloud component associating one or more semantic instruction with the row-based world model; and
the cloud component communicating the row-based world model to the AV.

9. The system of claim 8 wherein the cloud component includes a computer vision module that detects the perimeter of the field from the map image.

10. The system of claim 8 wherein the cloud component includes a computer vision module that detects the row distance between the at least two rows.

11. The system of claim 8 wherein the cloud component includes a computer vision module that detects an end of each row and a beginning of each row.

12. The system of claim 8 wherein the plant type is determined from a user input.

13. The system of claim 8 wherein the row-based world model includes a plant height and the cloud component generates a 2.5-D world model that includes the plant height.

14. The system of claim 8 wherein the row-based world model includes a 2-D world model having a plurality of horizontal information gathered from the map image.

15. An autonomous vehicle (AV) that receives a row-based world model for perceptive navigation of the AV, the AV comprising:
a memory that receives the row-based world model;
a communication channel that communicates with a cloud component that generates the row-based world model and transmits the row-based world model to the memory corresponding to the AV; and
wherein the cloud component performs the steps of:
determining a perimeter for a field,
determining a row distance between at least two rows,
determining a plant type for a plurality of plants,
determining an orientation for one or more rows,
generating a row-based frame of reference, in which each row has an associated frame of reference that includes a distance, wherein a location is determined based on a row number and the distance associated with the row number, and
generating the row-based world model with the row-based frame of references.

16. The AV of claim 16 wherein the cloud component includes a computer vision module that detects the perimeter of the field from the map image.

17. The AV of claim 16 wherein the cloud component includes a computer vision module that detects the row distance between the at least two rows.

18. The AV of claim 16 wherein the cloud component includes a computer vision module that detects an end of each row and a beginning of each row.

19. The AV of claim 16 wherein the plant type is determined from a user input.

20. The AV of claim 16 wherein the row-based world model includes a plant height and the cloud component generates a 2.5-D world model that includes the plant height.
